(19) United States
(12) Patent Application Publication
(10) Pub. No.: US 2025/0147283 A1
(43) Pub. Date: May 8, 2025

(54) OPTICAL CAMERA LENS ASSEMBLY

(71) Applicant: Zhejiang Sunny Optics Co., Ltd, Yuyao City (CN)

(72) Inventors: Xiaoni Wang, Yuyao City (CN); Li Chen, Yuyao City (CN); Linlin Xia, Yuyao City (CN); Xudong Zheng, Yuyao City (CN); Rongbo Fang, Yuyao City (CN); Jianke Wenren, Yuyao City (CN); Fujian Dai, Yuyao City (CN)

(21) Appl. No.: 18/935,270

(22) Filed: Nov. 1, 2024

(30) Foreign Application Priority Data
Nov. 2, 2023 (CN) 202311446651.9

(51) Int. Cl. G02B 13/00; G02B 7/02; G02B 9/62

(52) U.S. Cl. CPC G02B 13/0045; G02B 7/021; G02B 9/62

(57) ABSTRACT

An optical camera lens assembly is provided. The optical camera lens assembly comprises a lens group, a plurality of separating pieces, and a lens barrel used to accommodate the lens group and the plurality of separating pieces. The lens group is composed of six lenses having a refractive power, and comprises, sequentially along an optical axis from an object side to an image side, a first lens, a second lens, a third lens, a fourth lens, a fifth lens and a sixth lens that have a refractive power. The plurality of separating pieces comprise a first separating piece, a second separating piece, a third separating piece, a fourth separating piece and a fifth separating piece. The optical camera lens assembly may satisfy: 10<(EP45+CP5)/T56<40.0, 0<d5s/f5<1.0 and 0<d5s/f6<1.0.

### CROSS-REFERENCE TO RELATED APPLICATIONS

This application claims the priority from Chinese Patent Application No. 202311446651.9, filed in the National Intellectual Property Administration (CNIPA) on Nov. 2, 2023, the contents of which are hereby incorporated by reference in their entirety.

### TECHNICAL FIELD

The present disclosure relates to the field of optical elements, and specifically to an optical camera lens assembly.

### BACKGROUND

With the increasingly competitive market of portable electronic devices such as smartphones, numerous mobile terminal manufacturers have begun to spare no effort to invest in the process and technical improvement of mobile phones, where the shooting function of the mobile phones has become one of the main directions to improve the competitiveness of the mobile phones.

Generally, in design of a lens assembly, many lens assembly designers pay more attention to how to make the shooting range of the lens assembly wider and optimize the distortion effect better. In order to improve the stability of assembling of the portions of the camera lens assembly close to the image plane and reduce the sensitivity of lenses, it is required to better control the spacing distance, etc., and thus many adverse effects of stray light and other phenomena on the lens assembly are ignored.

### SUMMARY

An aspect of the present disclosure provides an optical camera lens assembly. The optical camera lens assembly includes a lens group, a plurality of separating pieces, and a lens barrel that is used to accommodate the lens group and the plurality of separating pieces. The lens group is composed of six lenses having refractive powers, and includes, sequentially along an optical axis from an object side to an image side, a first lens, a second lens, a third lens, a fourth lens, a fifth lens and a sixth lens that have refractive powers. The plurality of separating pieces include: a first separating piece, positioned on an image side of the first lens and partially in contact with an image-side surface of the first lens; a second separating piece, positioned on an image side of the second lens and partially in contact with an image-side surface of the second lens; a third separating piece, positioned on an image side of the third lens and partially in contact with an image-side surface of the third lens; a fourth separating piece, positioned on an image side of the fourth lens and partially in contact with an image-side surface of the fourth lens; and a fifth separating piece, positioned on an image side of the fifth lens and partially in contact with an image-side surface of the fifth lens. The optical camera lens assembly satisfies: 10<(EP45+CP5)/T56<40.0, 0<d5s/f5<1.0 and 0<d5s/f6<1.0, where EP45 is a spacing distance from an image-side surface of the fourth separating piece to an object-side surface of the fifth separating piece in a direction of the optical axis, CP5 is a maximal thickness of the fifth separating piece along the direction of the optical axis, T56 is an air spacing between the fifth lens and the sixth lens on the optical axis, f5 is an effective focal length of the fifth lens, f6 is an effective focal length of the sixth lens, and d5s is an inner diameter of the object-side surface of the fifth separating piece.

In an implementation, at least one of the surfaces from the object-side surface of the first lens to the image-side surface of the sixth lens is an aspheric surface.

In an implementation, the optical camera lens assembly satisfies: 0<f2/f<110 and −1.0<EP12/f2−EP12/R4<0, where f2 is an effective focal length of the second lens, f is a total effective focal length of the optical camera lens assembly, EP12 is a spacing distance from an image-side surface of the first separating piece to an object-side surface of the second separating piece in the direction of the optical axis, and R4 is a radius of curvature of the image-side surface of the second lens.

In an implementation, the optical camera lens assembly satisfies: −1.0<f3/f4<0 and 1.5<d3s/f3−D3s/f4<2.5, where f3 is an effective focal length of the third lens, f4 is an effective focal length of the fourth lens, d3s is an inner diameter of an object-side surface of the third separating piece, and D3s is an outer diameter of the object-side surface of the third separating piece.

In an implementation, the optical camera lens assembly satisfies: −5.0<f4/(EP34+CT4)<−2.0, where f4 is an effective focal length of the fourth lens, EP34 is a spacing distance from an image-side surface of the third separating piece to an object-side surface of the fourth separating piece in the direction of the optical axis, and CT4 is a center thickness of the fourth lens on the optical axis.

In an implementation, the optical camera lens assembly satisfies: 1.62<(N4+N5)/2<1.80 and 0<d4s/|(f4+f5)|<1.0, where N4 is a refractive index of the fourth lens, N5 is a refractive index of the fifth lens, d4s is an inner diameter of an object-side surface of the fourth separating piece, and f4 is an effective focal length of the fourth lens.

In an implementation, the optical camera lens assembly satisfies: 3.0<L/(CT5+T56+CT6)<4.0, where L is a spacing distance from an object-side end of the lens barrel to an image-side end of the lens barrel in the direction of the optical axis, CT5 is a center thickness of the fifth lens on the optical axis, and CT6 is a center thickness of the sixth lens on the optical axis.

In an implementation, the optical camera lens assembly satisfies: 5 mm<D5s/|R8/R9|<10.0 mm, where D5s is an outer diameter of the object-side surface of the fifth separating piece, R8 is a radius of curvature of the image-side surface of the fourth lens, and R9 is a radius of curvature of an object-side surface of the fifth lens.

In an implementation, the optical camera lens assembly satisfies: −10.0<R9/R12<−1.0 and 4.0<f56/(EP45+T56)<10.0, where R9 is a radius of curvature of an object-side surface of the fifth lens, R12 is a radius of curvature of an image-side surface of the sixth lens, and f56 is a combined focal length of the fifth lens and the sixth lens.

In an implementation, the optical camera lens assembly satisfies: −2.0<d0s/R1<−0.5, where R1 is a radius of curvature of an object-side surface of the first lens, and d0s is an inner diameter of an object-side end of the lens barrel.

In an implementation, the optical camera lens assembly satisfies: 110.0°<FOV<120.0° and 0.3<d0s/d0m<0.7, where FOV is a maximal field-of-view of the optical camera lens assembly, d0s is an inner diameter of an object-side end of the lens barrel, and d0m is an inner diameter of an image-side end of the lens barrel.

In an implementation, a maximal diameter of any lens in the first lens to the fourth lens is smaller than a maximal diameter of the fifth lens.

In an implementation, surfaces of the first lens and/or the sixth lens have at least one inflection point.

In an implementation, the surfaces of the first lens have at least one inflection point, and the optical camera lens assembly satisfies: 0<(DT11−Yc11)/d1s<0.6, where DT11 is a maximal effective radius of the object-side surface of the first lens, Yc11 is a distance along a direction perpendicular to the optical axis between an inflection point on the object-side surface of the first lens and an intersection point of the object-side surface of the first lens and the optical axis, and d1s is an inner diameter of an object-side surface of the first separating piece.

In an implementation, the surfaces of the sixth lens have at least one inflection point, and the optical camera lens assembly satisfies: 2.0<d5s/Yc62<3.0, where Yc62 is a distance along a direction perpendicular to the optical axis between an inflection point on the image-side surface of the sixth lens and an intersection point of the image-side surface of the sixth lens and the optical axis.

In an implementation, the plurality of separating pieces further comprise: a fifth auxiliary separating piece, positioned on an image side of the fifth separating piece and partially in contact with an image-side surface of the fifth separating piece; and a fifth secondary auxiliary separating piece, positioned on an image side of the fifth auxiliary separating piece and partially in contact with an image-side surface of the fifth auxiliary separating piece. The optical camera lens assembly satisfies: 0<(d5bm+d5 cm)/f6<2.0, where d5bm is an inner diameter of the image-side surface of the fifth auxiliary separating piece, and d5 cm is an inner diameter of an image-side surface of the fifth secondary auxiliary separating piece.

In an implementation, the object-side surface of the first lens is a concave surface, and the image-side surface of the first lens is a convex surface; the second lens has a positive refractive power, an object-side surface of the second lens is a convex surface, and the image-side surface of the second lens is a concave surface; the third lens has a positive refractive power, an object-side surface of the third lens is a convex surface, and the image-side surface of the third lens is a convex surface; the fourth lens has a negative refractive power, an object-side surface of the fourth lens is a concave surface, and the image-side surface of the fourth lens is a convex surface; the fifth lens has a positive refractive power, the object-side surface of the fifth lens is a concave surface, and the image-side surface of the fifth lens is a convex surface; and the sixth lens has a positive refractive power, an object-side surface of the sixth lens is a convex surface, and the image-side surface of the sixth lens is a concave surface.

In an exemplary implementation of the present disclosure, through the reasonable settings for the six lenses, the plurality of separating pieces and the lens barrel and by satisfying 10<(EP45+CP5)/T56<40.0, the thicknesses, imaging quality and spacing distance of the fifth lens and the sixth lens can be better controlled, to reduce the sensitivity of the lens at this position and the impact on the imaging quality of the camera lens assembly. Meanwhile, it helps to improve the stability of assembling of the portions of the camera lens assembly close to the image plane. However, this design easily affects the subsequent transmission of light and the generated stray light. On this basis, by satisfying 0<d5s/f5<1.0 and 0<d5s/f6<1.0, the effective focal lengths of the fifth lens and the sixth lens and the inner diameter of the object-side surface of the fifth separating piece can be reasonably controlled, which can enhance the divergence effect of light, and help to control the dispersion state of the light when transmitted to the sixth lens and ensure the uniformity of light when diverging from the sixth lens to the image plane, thereby improving the overall image quality. Meanwhile, the problem with the white arc stray light generated in the non-optical area of the fifth lens can also be improved, which reduces the impact of the stray light of the fifth lens on the overall camera lens assembly, thereby improving the imaging quality of the optical camera lens assembly.

### BRIEF DESCRIPTION OF THE DRAWINGS

After reading detailed descriptions of non-limiting embodiments given with reference to the following accompanying drawings, other features, objectives and advantages of the present disclosure will become more apparent.

FIG. 1 is a schematic structural diagram of an optical camera lens assembly of Embodiment 1;

FIG. 2 is a schematic structural diagram of an optical camera lens assembly of Embodiment 2;

FIG. 3 is a schematic structural diagram of an optical camera lens assembly of Embodiment 3;

FIGS. 4A-4D respectively illustrate a longitudinal aberration curve, an astigmatic curve, a distortion curve and a lateral color curve of the optical camera lens assemblies of Embodiments 1-3;

FIG. 5 is a schematic structural diagram of an optical camera lens assembly of Embodiment 4;

FIG. 6 is a schematic structural diagram of an optical camera lens assembly of Embodiment 5;

FIG. 7 is a schematic structural diagram of an optical camera lens assembly of Embodiment 6;

FIGS. 8A-8D respectively illustrate a longitudinal aberration curve, an astigmatic curve, a distortion curve and a lateral color curve of the optical camera lens assemblies of Embodiments 4-6;

FIG. 9 is a schematic structural diagram of an optical camera lens assembly of Embodiment 7;

FIG. 10 is a schematic structural diagram of an optical camera lens assembly of Embodiment 8;

FIG. 11 is a schematic structural diagram of an optical camera lens assembly of Embodiment 9;

FIGS. 12A-12D respectively illustrate a longitudinal aberration curve, an astigmatic curve, a distortion curve and a lateral color curve of the optical camera lens assemblies of Embodiments 7-9;

FIG. 13 is a schematic diagram of some parameters of an optical camera lens assembly according to an embodiment of the present disclosure;

FIG. 14 is a white arc spot diagram of a stray light energy angle of an optical camera lens assembly of the present disclosure;

FIG. 15 is a white arc spot diagram of a stray light energy angle of an other optical camera lens assembly of the present disclosure; and

FIG. 16 is a white arc spot diagram of a stray light energy angle of an other optical camera lens assembly of the present disclosure.

### DETAILED DESCRIPTION OF EMBODIMENTS

For a better understanding of the present disclosure, various aspects of the present disclosure will be described in more detail with reference to the accompanying drawings. It should be understood that the detailed description is merely an illustration for the exemplary implementations of the present disclosure, rather than a limitation to the scope of the present disclosure in any way. Throughout the specification, the same reference numerals designate the same elements. The expression “and/or” includes any and all combinations of one or more of the associated listed items.

It should be noted that, in the specification, the expressions such as “first,” “second” and “third” are only used to distinguish one feature from another, rather than represent any limitations to the features. Thus, without departing from the teachings of the present disclosure, the first lens discussed below may also be referred to as the second lens or the third lens, and the first separating piece discussed below may also be referred to as the second separating piece or the third separating piece.

In the accompanying drawings, the thicknesses, sizes and shapes of the lenses are slightly exaggerated for the convenience of explanation. Specifically, the shapes of spherical surfaces or aspheric surfaces shown in the accompanying drawings are shown by examples. That is, the shapes of the spherical surfaces or the aspheric surfaces are not limited to the shapes of the spherical surfaces or the aspheric surfaces shown in the accompanying drawings. It should be understood that, in the accompanying drawings, the thicknesses, sizes and shapes of the separating pieces and the lens barrel are also slightly exaggerated for the convenience of explanation.

Herein, a paraxial area refers to an area near an optical axis. If a lens surface is a convex surface and the position of the convex surface is not defined, it represents that the lens surface is a convex surface at least at the paraxial area. If the lens surface is a concave surface and the position of the concave surface is not defined, it represents that the lens surface is a concave surface at least at the paraxial area. A surface of each lens that is closest to a photographed object is referred to as the object-side surface of the lens, and a surface of each lens that is closest to an image plane is referred to as the image-side surface of the lens. It should be understood that a surface of each separating piece that is closest to the photographed object is referred to as the object-side surface of the separating piece, and a surface of each separating piece that is closest to the image plane is referred to as the image-side surface of the separating piece. A surface of the lens barrel that is closest to the photographed object is referred to as the object-side end of the lens barrel, and a surface of the lens barrel that is closest to the image plane is referred to as the image-side end of the lens barrel.

It should be further understood that the terms “comprise,” “comprising,” “having,” “include” and/or “including,” when used in the specification, specify the presence of stated features, elements and/or components, but do not exclude the presence or addition of one or more other features, elements, components and/or combinations thereof. In addition, expressions such as “at least one of,” when preceding a list of listed features, modify the entire list of features rather than an individual element in the list. Further, the use of “may,” when describing the implementations of the present disclosure, represents “one or more implementations of the present disclosure.” Also, the term “exemplary” is intended to refer to an example or illustration.

Unless otherwise defined, all terms (including technical and scientific terms) used herein have the same meaning as commonly understood by those of ordinary skill in the art to which the present disclosure belongs. It should be further understood that terms (e.g., those defined in commonly used dictionaries) should be interpreted as having a meaning that is consistent with their meaning in the context of the relevant art and will not be interpreted in an idealized or overly formal sense unless expressly so defined herein.

It should be noted that embodiments in the present disclosure and the features in the embodiments may be combined with each other on a non-conflict basis. The following embodiments only express several implementations of the present disclosure, and the descriptions thereof are relatively specific and detailed, but cannot be understood as a limitation to the scope of the present disclosure. It should be pointed out that, for those of ordinary skill in the art, several variations and improvements can be made without departing from the concept of the present disclosure, and these variations and improvements all fall within the scope of protection of the present disclosure. For example, the lens groups (i.e., the first to the sixth lenses), the lens barrel structure and the separating pieces in each embodiment of the present disclosure can be combined arbitrarily, and the present disclosure is not limited to enabling the lens group in one embodiment to be combined only with the lens barrel structure and the separating pieces in this embodiment. Embodiments of the present disclosure will be described below in detail with reference to the accompanying drawings.

Features, principles and other aspects of the present disclosure are described below in detail.

An optical camera lens assembly according to exemplary implementations of the present disclosure may include six lenses having refractive powers, and the six lenses are respectively a first lens, a second lens, a third lens, a fourth lens, a fifth lens and a sixth lens. The six lenses are arranged sequentially along an optical axis from an object side to an image side. There may be a spacing distance between any two adjacent lenses in the first to sixth lenses. Any one of the first to sixth lenses may have a center thickness on the optical axis.

According to an exemplary implementation of the present disclosure, the first to sixth lens may each have an optical area for optical imaging and a non-optical area extending outward from the periphery of the optical area. Generally speaking, the optical area refers to the area of the lens for optical imaging, and the non-optical area refers to the structure area of the lens. During the assembling of the optical camera lens assembly, through processes such as a dispensing and bonding process, a separating piece may be disposed at the non-optical area of each lens and each lens may be coupled into the lens barrel. During the imaging of the optical camera lens assembly, the light from an object may pass through the optical area of each lens to form an optical path, thus forming a final optical image. The non-optical area of each lens after the assembling is accommodated in the light-blocking lens barrel, and accordingly, the non-optical area does not directly take part in the imaging process of the optical camera lens assembly. It should be noted that, for ease of description, each lens is divided into two portions (i.e., the optical area and the non-optical area) for description in embodiments of the present disclosure, but it should be understood that, during the manufacturing, the optical area and the non-optical area of the lens may be formed as a whole, rather than as two separate portions.

In an implementation of the present disclosure, the optical lens assembly may include at least one separating piece, for example, may include at least one of a first separating piece, a second separating piece, a third separating piece, a fourth separating piece and a fifth separating piece. The first separating piece may be positioned on an image side of the first lens and partially in contact with an image-side surface of the first lens, and may be supported against the non-optical area of the image-side surface of the first lens. The second separating piece may be positioned on an image side of the second lens and partially in contact with an image-side surface of the second lens, and may be supported against the non-optical area of the image-side surface of the second lens. The third separating piece may be positioned on an image side of the third lens and partially in contact with an image-side surface of the third lens, and may be supported against the non-optical area of the image-side surface of the third lens. The fourth separating piece may be positioned on an image side of the fourth lens and partially in contact with an image-side surface of the fourth lens, and may be supported against the non-optical area of the image-side surface of the fourth lens. The fifth separating piece may be positioned on an image side of the fifth lens and partially in contact with an image-side surface of the fifth lens, and may be supported against the non-optical area of the image-side surface of the fifth lens. As an example, the first separating piece may be in contact with the non-optical area of the image-side surface of the first lens, and at the same time, may be in contact with the non-optical area of the object-side surface of the second lens. For example, the object-side surface of the first separating piece may be in contact with the non-optical area of the image-side surface of the first lens, and the image-side surface of the first separating piece may be in contact with the non-optical area of the object-side surface of the second lens.

In another implementation of the present disclosure, the optical camera lens assembly may further include a fifth auxiliary separating piece and/or a fifth secondary auxiliary separating piece. The fifth auxiliary separating piece may be positioned on an image side of the fifth separating piece and partially in contact with an image-side surface of the fifth separating piece. The fifth secondary auxiliary separating piece may be positioned on an image side of the fifth auxiliary separating piece and partially in contact with an image-side surface of the fifth auxiliary separating piece.

The optical camera lens assembly according to the exemplary implementations of the present disclosure may include a lens barrel that accommodates a lens group and a plurality of separating pieces. As an example, as shown in FIG. 1, the lens barrel P0 may be used to accommodate the first lens E1 to the sixth lens E6 and the first separating piece P1 to the fifth secondary auxiliary separating piece P5c.

According to an exemplary implementation of the present disclosure, the separating pieces may include at least one spacer. By reasonably setting the quantity, thickness, inner diameter and outer diameter of the spacer, it helps to improve the assembling of the optical camera lens assembly and block stray light, thereby improving the imaging quality of the optical camera lens assembly.

In an exemplary implementation, the first lens may have a positive refractive power or a negative refractive power, the object-side surface of the first lens may be a concave surface, and the image-side surface of the first lens may be a convex surface. The second lens may have a positive refractive power, the object-side surface of the second lens may be a convex surface, and the image-side surface of the second lens may be a concave surface. The third lens may have a positive refractive power, the object-side surface of the third lens may be a convex surface, and the image-side surface of the third lens may be a convex surface. The fourth lens may have a negative refractive power, the object-side surface of the fourth lens may be a concave surface, and the image-side surface of the fourth lens may be a convex surface. The fifth lens may have a positive refractive power, the object-side surface of the fifth lens may be a concave surface, and the image-side surface of the fifth lens may be a convex surface. The sixth lens may have a positive refractive power, the object-side surface of the sixth lens may be a convex surface, and the image-side surface of the sixth lens may be a concave surface. In an exemplary implementation, the optical camera lens assembly according to embodiments of the present disclosure may satisfy: 10<(EP45+CP5)/T56<40.0, 0<d5s/f5<1.0 and 0<d5s/f6<1.0. Here, EP45 is the spacing distance from the image-side surface of the fourth separating piece to the object-side surface of the fifth separating piece in the direction of the optical axis (FIG. 13), CP5 is the maximal thickness of the fifth separating piece along the direction of the optical axis, T56 is the air spacing between the fifth lens and the sixth lens on the optical axis (FIG. 13), f5 is the effective focal length of the fifth lens, f6 is the effective focal length of the sixth lens, and d5s is the inner diameter of the object-side surface of the fifth separating piece. More specifically, d5s and f5 may further satisfy: 0.1<d5s/f5<1.0, and d5s and f6 may further satisfy: 0.1<d5s/f6<0.5.

Embodiments of the present disclosure provide a lens assembly having six lenses. Generally, the larger EP45 is, the worse the stability of assembling of the lens assembly is. Therefore, to meet the requirements on the stability of the lens assembly, it may reasonably set the range of EP45. In embodiments of the present disclosure, through the above reasonable settings for the six lenses, the plurality of separating pieces and the lens barrel and by satisfying 10<(EP45+CP5)/T56<40.0, the thicknesses, imaging quality of the fifth lens and the sixth lens and spacing distance between the fifth lens and the sixth lens can be better controlled, to reduce the sensitivity of the lens at this position and the impact on the imaging quality of the camera lens assembly. Meanwhile, it helps to improve the stability of assembling of the portions of the camera lens assembly close to the image plane. However, this design easily affects the subsequent transmission of light and the generated stray light. On this basis, by satisfying 0<d5s/f5<1.0 and 0<d5s/f6<1.0, the effective focal lengths of the fifth lens and the sixth lens and the inner diameter of the object-side surface of the fifth separating piece can be reasonably controlled, which can enhance the divergence effect of light, and help to control the dispersion state of the light when transmitted to the sixth lens and ensure the uniformity of light when diverging from the sixth lens to the image plane, thereby improving the overall image quality. Meanwhile, the problem with the white arc stray light generated in the non-optical area of the fifth lens can also be improved, which reduces the impact of the stray light of the fifth lens on the overall camera lens assembly, thereby improving the imaging quality of the optical camera lens assembly.

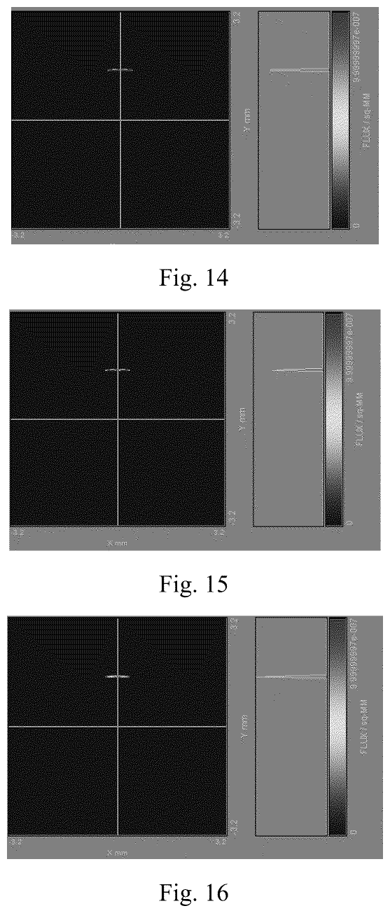

As shown in FIG. 14, FIG. 14 is a white arc spot diagram of a stray light energy angle of the optical camera lens assembly satisfying 1<(EP45+CP5)/T56<10, d5s/f5<0 and d5s/f6<0 (e.g., (EP45+CP5)/T56=8.90, d5s/f5=−0.82 and d5s/f6=−0.37), where the stray light of the optical camera lens assembly has the maximal energy intensity that is approximately 0.000001415 1m/mm² and the total energy intensity that is approximately 0.000000036 1m. As shown in FIG. 15, FIG. 15 is a white arc spot diagram of a stray light energy angle of the optical camera lens assembly satisfying (EP45+CP5)/T56>40, d5s/f5>1.0 and d5s/f6>1.0 (e.g., (EP45+CP5)/T56=43.14, d5s/f5=1.52 and d5s/f6=1.43), where the stray light of the optical camera lens assembly has the maximal energy intensity that is approximately 0.000001471 1m/mm² and the total energy intensity that is approximately 0.000000033 1m. As shown in FIG. 16, FIG. 16 is a white arc spot diagram of a stray light energy angle of the optical camera lens assembly satisfying 10<(EP45+CP5)/T56<40.0, 0<d5s/f5<1.0 and 0<d5s/f6<1.0 (e.g., (EP45+CP5)/T56=24.46, d5s/f5=0.61 and d5s/f6=0.38), where the stray light of the optical camera lens assembly has the maximal energy intensity that is approximately 0.000000515 1m/mm² and the total energy intensity that is approximately 0.000000013 1m.

It can be seen from FIGS. 14-16 that, as compared with the white arc light spot diagrams of the stray light energy angles of the optical camera lens assemblies shown in FIGS. 14 and 15, the maximal energy intensity of the stray light in the white arc light spot diagram of the stray light energy angle of the optical camera lens assembly shown in FIG. 16 is smaller. It can be seen that, when the optical technical parameters d5s/f5 and d5s/f6 are controlled within a reasonable range, for example, controlled to satisfy 0<d5s/f5<1.0 and 0<d5s/f6<1.0, the maximal energy intensity of the stray light of the optical camera lens assembly is smaller, and the stray light is significantly reduced, and accordingly, the stray light improvement effect is better.

In an exemplary implementation, the optical camera lens assembly according to embodiments of the present disclosure may satisfy: 0<f2/f<110 and −1.0<EP12/f2−EP12/R4<0. Here, f2 is the effective focal length of the second lens, f is the total effective focal length of the optical camera lens assembly, EP12 is the spacing distance from the image-side surface of the first separating piece to the object-side surface of the second separating piece in the direction of the optical axis (FIG. 13), and R4 is the radius of curvature of the image-side surface of the second lens. When 0<f2/f<110 and −1.0<EP12/f2−EP12/R4<0 are satisfied, it is can make the radius of curvature of the surface of the second lens small on the basis of ensuring the effective focal length of the second lens and the total effective focal length of the lens assembly, resulting in a good molding effect. It can improve the stability of assembling of the lens assembly by controlling the spacing distance from the image-side surface of the first separating piece to the object-side surface of the second separating piece. In addition, it can control the thickness of the second lens and the air spacing between the first lens and the second lens within a reasonable range, to improve the selectivity of the first separating piece and the second separating piece, thereby improving the stray light. Accordingly, it helps to improve the stray light quality of the overall lens assembly.

In an exemplary implementation, the optical camera lens assembly according to embodiments of the present disclosure may satisfy: −1.0<f3/f4<0 and 1.5<d3s/f3−D3s/f4<2.5. Here, f3 is the effective focal length of the third lens, f4 is the effective focal length of the fourth lens, d3s is the inner diameter of the object-side surface of the third separating piece (FIG. 13), and D3s is the outer diameter of the object-side surface of the third separating piece (FIG. 13). When −1.0<f3/f4<0 and 1.5<d3s/f3−D3s/f4<2.5 are satisfied, it can not only control the effective focal length of the optical camera lens assembly within a reasonable range, but also reduce the leakage problem of the light passing through the third lens and the fourth lens. In addition, by controlling the effective focal lengths of the third lens and the fourth lens, it can reasonably constrain the sizes of the outer diameters of the third lens and the fourth lens, and control the sizes of the inner diameters of the third lens and the fourth lens synchronously, to block the leakage light beams passing through the edges of the effective diameters of the third lens and the fourth lens, thereby reducing the risk of light leakage and improving the imaging quality of the lens assembly.

In an exemplary implementation, the optical camera lens assembly according to embodiments of the present disclosure may satisfy: −5.0<f4/(EP34+CT4)<− 2.0. Here, f4 is the effective focal length of the fourth lens, EP34 is the spacing distance from the image-side surface of the third separating piece to the object-side surface of the fourth separating piece in the direction of the optical axis (FIG. 13), and CT4 is the center thickness of the fourth lens on the optical axis. When −5.0<f4/(EP34+CT4)<−2.0 is satisfied, it can not only ensure the height of the light passing through the fourth lens to satisfy the image height requirement of the optical camera lens, but also reasonably set the outer contour of the fourth lens by controlling the spacing distance between the image-side surface of the third separating piece and the object-side surface of the fourth separating piece along the direction of the optical axis and the center thickness of the fourth lens on the optical axis, which controls the height of the light passing through the fourth lens to ensure the imaging height of the optical camera lens assembly, thereby satisfying the shooting effect.

In an exemplary implementation, the optical camera lens assembly according to embodiments of the present disclosure may satisfy: 1.62<(N4+N5)/2<1.80 and 0<d4s/|(f4+f5)|<1.0. Here, N4 is the refractive index of the fourth lens, N5 is the refractive index of the fifth lens, d4s is the inner diameter of the object-side surface of the fourth separating piece (FIG. 13), f4 is the effective focal length of the fourth lens, and f5 is the effective focal length of the fifth lens. When 1.62<(N4+N5)/2<1.80 and 0<d4s/|(f4+f5)|<1.0 are satisfied, it can control the dispersion state of the light when transmitted to the fifth lens. In addition, by controlling the refractive indexes of the fourth lens and the fifth lens, it can constrain the sizes of the outer diameters of the fourth lens and the fifth lens, and control the inner diameter of the object-side surface of the fourth separating piece synchronously, thereby reducing the risk of light leakage and improving the imaging quality of the lens assembly.

In an exemplary implementation, the optical camera lens assembly according to embodiments of the present disclosure may satisfy: 3.0<L/(CT5+T56+CT6)<4.0. Here, L is the spacing distance from the object-side end of the lens barrel to the image-side end of the lens barrel in the direction of the optical axis (FIG. 13), CT5 is the center thickness of the fifth lens on the optical axis, CT6 is the center thickness of the sixth lens on the optical axis, and T56 is the air spacing between the fifth lens and the sixth lens on the optical axis. When 3.0<L/(CT5+T56+CT6)<4.0 is satisfied, it can be ensured that the sixth lens is wrapped in the object-side end of the lens barrel, which avoids scratches on the image-side surface of the sixth lens, thereby avoiding the problems with the appearance of the lens assembly. Meanwhile, since the scratches on the image-side surface of the sixth lens will affect the stray-light ghost image effect of the optical camera lens assembly, the lens barrel is used to wrap the lens in embodiments of the present disclosure, which can effectively avoid the stray-light ghost image caused by lens scratches, thereby improving the imaging effect and imaging quality of the optical camera lens assembly.

In an exemplary implementation, the optical camera lens assembly according to embodiments of the present disclosure may satisfy: 5 mm<D5s/|R8/R9|<10.0 mm. Here, D5s is the outer diameter of the object-side surface of the fifth separating piece (FIG. 13), R8 is the radius of curvature of the image-side surface of the fourth lens, and R9 is the radius of curvature of the object-side surface of the fifth lens. When 5 mm<D5s/|R8/R9|<10.0 mm is satisfied, the degree of divergence of light can be controlled, which helps to transmit the light to the sixth lens more evenly. Moreover, by controlling the outer diameter of the object-side surface of the fifth separating piece, the sizes of the outer diameters of the fourth lens and the fifth lens can be controlled, to reduce the size of the segment difference between the lenses, thereby improving the feasibility of lens molding and the stability of assembling.

In an exemplary implementation, the optical camera lens assembly according to embodiments of the present disclosure may satisfy: −10.0<R9/R12<−1.0 and 4.0<f56/(EP45+T56)<10.0. Here, R9 is the radius of curvature of the object-side surface of the fifth lens, R12 is the radius of curvature of the image-side surface of the sixth lens, f56 is the combined focal length of the fifth lens and the sixth lens, and EP45 is the spacing distance from the image-side surface of the fourth separating piece to the object-side surface of the fifth separating piece in the direction of the optical axis (FIG. 13). When −10.0<R9/R12<−1.0 and 4.0<f56/(EP45+T56)<10.0 are satisfied, it can be ensured that the height of the light passing through the sixth lens can satisfy the image height requirement of the optical camera lens assembly. The combined focal length of the fifth lens and the sixth lens, the spacing distance between the fourth separating piece and the fifth separating piece and the air spacing between the fifth lens and the sixth lens on the optical axis jointly determine the appearances of the fifth lens and the sixth lens. When −10.0<R9/R12<−1.0 and 4.0<f56/(EP45+T56)<10.0 are satisfied, the height of the light passing through the fifth lens and the sixth lens can be controlled to ensure the imaging height of the optical camera lens assembly, thereby satisfying the shooting effect.

In an exemplary implementation, the optical camera lens assembly according to embodiments of the present disclosure may satisfy: −2.0<d0s/R1<0.5. Here, R1 is the radius of curvature of the object-side surface of the first lens, and d0s is the inner diameter of the object-side end of the lens barrel (FIG. 13). When −2.0<d0s/R1<−0.5 is satisfied, the shooting range (i.e., the size of the field-of-view) can be controlled by controlling the radius of curvature of the object-side surface of the first lens and the inner diameter of the object-side end of the lens barrel, thereby ensuring the performance needs of the optical camera lens assembly.

In an exemplary implementation, the optical camera lens assembly according to embodiments of the present disclosure may satisfy: 110.0°<FOV<120.0° and 0.3<d0s/d0m<0.7. Here, FOV is the maximal field-of-view of the optical camera lens assembly, d0s is the inner diameter of the object-side end of the lens barrel (FIG. 13), and d0m is the inner diameter of the image-side end of the lens barrel (FIG. 13). When 110.0°<FOV<120.0° and 0.3<d0s/d0m<0.7 are satisfied, it can not only enable the inner diameter of the object-side end of the lens barrel to allow the light from a certain field of view to enter, but also reduce the blocking of light by the image-side end of the lens barrel, which is conducive to ensuring the normal shooting demands.

In an exemplary implementation, the maximal diameter of any lens in the first lens to the fourth lens is smaller than the maximal diameter of the fifth lens. This setting helps to improve the stability of assembling of the fifth lens, thereby improving the stability of assembling and the practicality of the optical camera lens assembly. As an example, the maximal diameters of the first to fifth lenses may increase sequentially. In this way, it can be ensured that the outer diameter of the separating piece on the image side of each lens is greater than the maximal outer diameter of the lens, which can ensure that the optical path of the stray light in the non-optical area can be completely blocked, thereby improving the shooting quality of the optical camera lens assembly.

In an exemplary implementation, the surfaces of the first lens and/or the sixth lens have at least one inflection point. In other words, the object-side surface or image-side surface of at least one of the first lens and the sixth lens has at least one inflection point. This setting can raise the height of the light passing through the lens, which is conducive to adjusting the light largely, and facilitating the mutual compensation between the spherical aberrations of the lens. Moreover, the low-order aberrations of the overall lens assembly can be synchronously balanced.

In an exemplary implementation, the surfaces of the first lens have at least one inflection point. The optical camera lens assembly according to embodiments of the present disclosure may satisfy: 0<(DT11−Yc11)/d1s<0.6. Here, DT11 is the maximal effective radius of the object-side surface of the first lens, Yc11 is the distance along the direction perpendicular to the optical axis between the inflection point on the object-side surface of the first lens and the intersection point of the object-side surface of the first lens and the optical axis (i.e., Yc11 is the vertical distance from the inflection point on the object-side surface of the first lens to the optical axis), and d1s is the inner diameter of the object-side surface of the first separating piece. In embodiments of the present disclosure, the object-side surface of the first lens has an inflection point, which is conducive to the convergence of the light from various fields of view of the lens assembly. When 0<(DT11−Yc11)/d1s<0.6 is satisfied, it helps to control the ratio of the difference value between the maximal effective radius of the object-side surface of the first lens and the vertical distance from the inflection point to the optical axis to the inner diameter of the object-side surface of the first separating piece within a reasonable numerical range, which is conducive to reducing the size of the lens assembly and achieving the ultra-thinness of the lens assembly, thereby saving the space occupied by the lens assembly.

In an exemplary implementation, the surfaces of the sixth lens have at least one inflection point. The optical camera lens assembly according to embodiments of the present disclosure may satisfy: 2.0<d5s/Yc62<3.0. Here, d5s is the inner diameter of the object-side surface of the fifth separating piece (FIG. 13), and Yc62 is the distance along the direction perpendicular to the optical axis between the inflection point on the image-side surface of the sixth lens and the intersection point of the image-side surface of the sixth lens and the optical axis (FIG. 13). When 2.0<d5s/Yc62<3.0 is satisfied, the degree of inflection of the image-side surface of the sixth lens relatively close to the optical axis can be appropriately increased, such that the height difference between the light entering the sixth lens and the light exiting from the sixth lens is relatively large, thereby achieving the purpose of raising the height of the light passing through the sixth lens. Meanwhile, the inner diameter of the object-side surface of the fifth separating piece can be appropriately reduced to improve the effect of blocking the light exiting from the non-optical area of the fifth lens by the fifth separating piece, thereby reducing the white arc stray light generated in the non-optical area of the fifth lens.

In an exemplary implementation, the optical camera lens assembly according to embodiments of the present disclosure may satisfy: 0<(d5bm+d5 cm)/f6<2.0. Here, d5bm is the inner diameter of the image-side surface of the fifth auxiliary separating piece (FIG. 13), d5cm is the inner diameter of the image-side surface of the fifth secondary auxiliary separating piece (FIG. 13), and f6 is the effective focal length of the sixth lens. Generally, in design of a lens assembly, in order to satisfy the total effective focal length of the lens assembly, the air spacing between adjacent components may be increased. In embodiments of the present disclosure, by disposing the fifth auxiliary separating piece and the fifth secondary auxiliary separating piece to satisfy 0<(d5bm+d5 cm)/f6<2.0, it can not only improve the molding of the fifth separating piece, but also block, through the addition of the fifth auxiliary separating piece and the fifth secondary auxiliary separating piece, the optical path of the stray light reflected by the inner diameter surface of the fifth separating piece, thereby improving the imaging quality of the optical camera lens assembly.

In an exemplary implementation, the optical camera lens assembly according to embodiments of the present disclosure may further include a diaphragm disposed between the second lens and the third lens. Alternatively, the above optical camera lens assembly may further include an optical filter for correcting color deviations and/or a protective glass for protecting a photosensitive element on the image plane. Embodiments of the present disclosure proposes an optical camera lens assembly having characteristics such as a large field-of-view, less stray light, high stability, a high yield rate and a high imaging quality. The optical camera lens assembly according to the above implementations of the present disclosure may adopt a plurality of lenses, for example, the six lenses described above. By reasonably distributing the refractive powers, surface types, materials and center thicknesses of the lenses, the axial spacing distances between the lenses, etc., it can effectively converge the incident light, reduce the total track length of the imaging lens assembly and improve the processability of the imaging lens assembly, which makes the optical camera lens assembly easier to produce and process. In the optical camera lens assembly of the above implementations of the present disclosure, by disposing a separating piece between adjacent lenses and designing the inner and outer diameters of the separating piece according to the optical path, it can effectively block and eliminate stray light, thereby improving the imaging quality of the lens assembly.

In the implementations of the present disclosure, at least one of the surfaces of the lenses is an aspheric surface, that is, at least one of the surfaces from the object-side surface of the first lens to the image-side surface of the sixth lens is an aspheric surface. The aspheric lens is characterized in that the curvature continuously changes from the center of the lens to the periphery. Different from a spherical lens having a constant curvature from the center of the lens to the periphery, the aspheric lens has a better radius-of-curvature characteristic, and has advantages of improving the distortion aberration and the astigmatic aberration. The use of the aspheric lens can eliminate as much as possible the aberrations that occur during the imaging, thereby improving the imaging quality. Alternatively, at least one of the object-side surface and the image-side surface of each of the first lens, the second lens, the third lens, the fourth lens, the fifth lens and the sixth lens is an aspheric surface. Alternatively, the object-side surface and the image-side surface of each of the first lens, the second lens, the third lens, the fourth lens, the fifth lens and the sixth lens are both aspheric surfaces.

However, it should be understood by those skilled in the art that the various results and advantages described in the present specification may be obtained by changing the numbers of the lenses constituting the optical camera lens assembly without departing from the technical solution claimed by the present disclosure. For example, although the optical camera lens assembly having six lenses is described as an example in the implementations, the optical camera lens assembly is not limited to including the six lenses. If desired, the optical camera lens assembly may alternatively include other numbers of lenses.

Detailed embodiments of the optical camera lens assembly that may be applicable to the above implementations are further described below with reference to the accompanying drawings.

### Embodiment 1

An optical camera lens assembly according to Embodiment 1 of the present disclosure is described below with reference to FIG. 1. FIG. 1 illustrates the optical camera lens assembly of Embodiment 1.

As shown in FIG. 1, the optical camera lens assembly includes, sequentially from an object side to an image side, a first lens E1, a second lens E2, a diaphragm STO (not shown), a third lens E3, a fourth lens E4, a fifth lens E5, a sixth lens E6, an optical filter (not shown) and an image plane (not shown).

The first lens E1 has a negative refractive power, an object-side surface S1 of the first lens E1 is a concave surface, and an image-side surface S2 of the first lens E1 is a convex surface. The second lens E2 has a positive refractive power, an object-side surface S3 of the second lens E2 is a convex surface, and an image-side surface S4 of the second lens E2 is a concave surface. The third lens E3 has a positive refractive power, an object-side surface S5 of the third lens E3 is a convex surface, and an image-side surface S6 of the third lens E3 is a convex surface. The fourth lens E4 has a negative refractive power, an object-side surface S7 of the fourth lens E4 is a concave surface, and an image-side surface S8 of the fourth lens E4 is a convex surface. The fifth lens E5 has a positive refractive power, an object-side surface S9 of the fifth lens E5 is a concave surface, and an image-side surface S10 of the fifth lens E5 is a convex surface. The sixth lens E6 has a positive refractive power, an object-side surface S11 of the sixth lens E6 is a convex surface, and an image-side surface S12 of the sixth lens E6 is a concave surface. The optical filter has an object-side surface S13 and an image-side surface S14. Light from an object sequentially passes through the surfaces S1-S14, and finally forms an image on the image plane S15.

Table 1 is a table showing basic parameters of the optical camera lens assembly of Embodiment 1. Here, the units of a radius of curvature, a thickness/distance and a focal length are millimeters (mm).

TABLE 1

| | | | | material | | | |
|---|---|---|---|---|---|---|---|
| surface | surface | radius of | thickness/ | refractive | abbe | focal | conic |
| number | type | curvature | distance | index | number | length | coefficient |
| OBJ | spherical | infinite | | | | | |
| S1 | aspheric | −3.6012 | 0.6442 | 1.50 | 81.60 | −262.86 | −14.8582 |
| S2 | aspheric | −3.9233 | 0.1146 | | | | −1.9378 |
| S3 | aspheric | 3.0978 | 0.4439 | 1.58 | 30.00 | 23.35 | 0.5785 |
| S4 | aspheric | 3.7914 | 0.1919 | | | | −2.7482 |
| STO | spherical | infinite | 0.0658 | | | | |
| S5 | aspheric | 40.7109 | 0.8491 | 1.61 | 56.40 | 3.14 | −99.0000 |
| S6 | aspheric | −2.0156 | 0.5591 | | | | −0.0305 |
| S7 | aspheric | −2.0064 | 0.4662 | 1.68 | 19.20 | −4.36 | 0.3115 |
| S8 | aspheric | −6.8620 | 0.3069 | | | | 0.0000 |
| S9 | aspheric | −4.5660 | 0.8069 | 1.64 | 40.40 | 9.58 | −80.0000 |
| S10 | aspheric | −2.8069 | 0.0272 | | | | −0.1482 |
| S11 | aspheric | 1.2317 | 0.7115 | 1.62 | 37.20 | 15.33 | −1.0000 |
| S12 | aspheric | 1.1027 | 0.7516 | | | | −1.0140 |
| S13 | spherical | infinite | 0.2100 | 1.52 | 64.20 | | |
| S14 | spherical | infinite | 0.4285 | | | | |
| S15 | spherical | infinite | | | | | |

In this example, a total effective focal length f of the optical camera lens assembly is 3.17 mm, a maximal field-of-view FOV of the optical camera lens assembly is 116.0°, a combined focal length f56 of the fifth lens and the sixth lens is 5.01 mm, and a maximal effective radius DT11 of the object-side surface of the first lens is 2.27 mm. A distance along the direction perpendicular to the optical axis Yc11 between an inflection point on the object-side surface of the first lens and an intersection point of the object-side surface of the first lens and the optical axis is 1.48 mm, and a distance along the direction perpendicular to the optical axis Yc62 between an inflection point on the image-side surface of the sixth lens and an intersection point of the image-side surface of the sixth lens and the optical axis is 2.13 mm.

As shown in FIG. 1, the optical camera lens assembly may include seven separating pieces, which are respectively a first separating piece P1, a second separating piece P2, a third separating piece P3, a fourth separating piece P4, a fifth separating piece P5, a fifth auxiliary separating piece P5b and a fifth secondary auxiliary separating piece P5c. A lens barrel P0 can accommodate the first lens E1 to the sixth lens E6 and the first separating piece P1 to the fifth secondary auxiliary separating piece P5c.

Tables 2-1 and 2-2 are tables showing basic parameters of the separating pieces in the optical camera lens assembly of Embodiment 1. Here, the units of the parameters are millimeters (mm).

TABLE 2-1

| parameter | d1s | d3s | d4s | d5s | D5s | d0s | d0m |
|---|---|---|---|---|---|---|---|
| numerical value | 2.2600 | 2.1500 | 4.0028 | 5.8028 | 8.8600 | 5.5521 | 10.4200 |

TABLE 2-2

| parameter | EP12 | EP34 | EP45 | CP5 | L | d5bm | d5cm | D3s |
|---|---|---|---|---|---|---|---|---|
| numerical value | 0.5050 | 1.1741 | 0.6440 | 0.0220 | 6.0219 | 8.1597 | 7.4800 | 6.9000 |

It should be understood that, in this example, the structures and parameters of the separating pieces are only exemplarily listed, and the specific structures and actual parameters of the separating pieces are not explicitly defined. In actual production, the specific structures and actual parameters of the separating pieces can be set in any appropriate manner.

] In Embodiment 1, the object-side surface and the image-side surface of any lens in the first to sixth lenses E1-E6 are both aspheric surfaces, and the surface type X of each aspheric lens may be defined using, but not limited to, the following formula:

$$x = \frac{{ch}^{2}}{1 + \sqrt{1 - ( k + 1 ) {c}^{2} {h}^{2}}} + \sum {Aih}^{i} . \qquad ( 1 )$$

Here, X is the sag the axis-component of the displacement of the surface from the aspheric vertex, when the surface is at height h from the optical axis; c is the paraxial curvature of the aspheric surface, and c=1/R (i.e., the paraxial curvature c is the reciprocal of the radius of curvature R in Table 1 above); k is the conic coefficient; and Ai is the correction coefficient of an i-th order of the aspheric surface. Tables 3-1 and 3-2 below show the high-order coefficients A₄, A₆, A₈, A₁₀, A₁₂, A₁₄, A₁₆, A₁₈, A₂₀, A₂₂, A₂₄, A₂₆, A₂₈ and A₃₀ applicable to the aspheric surfaces S1-S12 in Embodiment 1.

TABLE 3-1

| surface | | | | | | | |
|---|---|---|---|---|---|---|---|
| number | A4 | A6 | A8 | A10 | A12 | A14 | A16 |
| S1 | 4.3006E−01 | −5.0185E−02 | 1.1837E−02 | −3.5741E−03 | 1.2653E−03 | −2.3709E−04 | 1.7610E−04 |
| S2 | 4.0705E−01 | −7.2939E−02 | 1.8208E−02 | −6.0380E−03 | 2.6357E−03 | −9.5875E−04 | 4.9339E−04 |
| S3 | −4.8212E−02 | −1.8847E−02 | 4.1967E−03 | −4.1526E−04 | 4.8501E−04 | −5.9879E−05 | 3.9058E−05 |
| S4 | −1.5882E−02 | −2.5207E−05 | 3.0200E−04 | 1.6838E−04 | 7.5083E−05 | 3.4643E−05 | 1.1467E−05 |
| S5 | −1.5809E−02 | −1.6329E−03 | −1.8377E−04 | −3.6571E−05 | 6.4666E−06 | 5.1301E−06 | 5.4525E−06 |
| S6 | −9.1526E−02 | −9.7218E−03 | −2.4286E−03 | −7.6610E−04 | −1.1407E−04 | −5.5682E−05 | 2.7990E−05 |
| S7 | −1.3773E−01 | 3.8888E−02 | −2.6670E−03 | −2.8106E−03 | 2.5728E−04 | −1.0720E−04 | −2.9262E−06 |
| S8 | −1.8331E−01 | 8.0810E−02 | 8.4250E−03 | −1.1794E−02 | 3.2918E−03 | −6.7534E−04 | 2.1038E−04 |
| S9 | 1.3085E−01 | −3.1500E−01 | 1.4820E−01 | −2.9164E−02 | 2.1307E−02 | −1.3095E−02 | 1.3965E−04 |
| S10 | 1.6680E+00 | −3.2439E−01 | 1.7452E−01 | −2.3907E−02 | 5.3372E−03 | 5.5582E−03 | −6.1539E−03 |
| S11 | −7.8145E+00 | 2.0029E+00 | −6.7968E−01 | 1.7606E−01 | −3.8722E−02 | 1.1014E−02 | −5.4940E−03 |
| S12 | 1.0229E+01 | 2.3318E+00 | −7.9592E−01 | 2.1163E−01 | −1.2175E−01 | 4.5719E−02 | −1.3964E−02 |

TABLE 3-2

| surface | | | | | | | |
|---|---|---|---|---|---|---|---|
| number | A18 | A20 | A22 | A24 | A26 | A28 | A30 |
| S1 | −3.5055E−06 | 5.9372E−06 | −8.9028E−07 | 4.8574E−07 | −1.6139E−06 | −8.7593E−06 | 4.7892E−06 |
| S2 | −2.0503E−04 | 1.0021E−04 | −4.2315E−05 | 2.3434E−05 | −2.0093E−05 | 7.6449E−06 | −9.8553E−07 |
| S3 | −1.0654E−05 | −2.3750E−06 | 5.8525E−06 | −1.2538E−06 | −5.1386E−07 | −3.8986E−06 | 1.6315E−06 |
| S4 | 5.5635E−06 | −7.6483E−07 | −1.6574E−06 | −1.7821E−06 | 7.0084E−07 | −4.9366E−07 | 1.4281E−07 |
| S5 | 1.0523E−06 | 3.6471E−06 | −1.7653E−07 | 1.4729E−06 | −5.9205E−07 | −1.2664E−07 | 1.6371E−08 |
| S6 | 2.9167E−07 | 1.8250E−05 | 1.3309E−07 | 5.8401E−06 | −4.3795E−06 | 1.4033E−06 | −1.6019E−07 |
| S7 | −4.3714E−07 | 1.4574E−05 | 4.3215E−06 | −5.8266E−07 | 2.9161E−06 | −2.6947E−06 | 1.1573E−06 |
| S8 | −1.1244E−04 | 7.3443E−05 | −2.2126E−05 | −6.4921E−06 | 1.5417E−05 | −1.0344E−05 | 2.0594E−06 |
| S9 | −1.2688E−03 | 1.7507E−03 | −6.1945E−05 | 1.3342E−04 | −2.3218E−04 | 1.4128E−05 | 1.7136E−05 |
| S10 | 4.9901E−03 | −2.3198E−03 | 1.9172E−04 | 3.7695E−05 | −5.9917E−05 | 2.7011E−04 | −8.1193E−05 |
| S11 | 5.8581E−03 | −4.7998E−03 | 3.6321E−03 | −2.9075E−03 | 1.5102E−03 | −4.0418E−04 | 4.7548E−05 |
| S12 | 9.5315E−03 | −6.3062E−03 | 3.8708E−03 | −1.5171E−03 | 8.8565E−04 | −5.1395E−04 | 2.4493E−04 |

### Embodiment 2

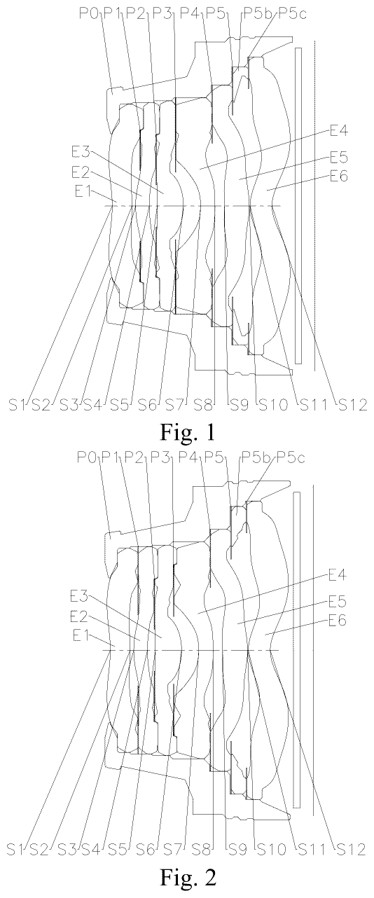

An optical camera lens assembly according to Embodiment 2 of the present disclosure is described below with reference to FIG. 2. In this embodiment and the following embodiments, for the sake of brevity, the descriptions similar to those in Embodiment 1 will be omitted. FIG. 2 illustrates the optical camera lens assembly of Embodiment 2.

As shown in FIG. 2, the optical camera lens assembly includes, sequentially from an object side to an image side, a first lens E1, a second lens E2, a diaphragm STO (not shown), a third lens E3, a fourth lens E4, a fifth lens E5, a sixth lens E6, an optical filter (not shown) and an image plane (not shown).

In this example, the structures and parameters of the first lens E1, the second lens E2, the diaphragm STO, the third lens E3, the fourth lens E4, the fifth lens E5, the sixth lens E6, the optical filter and the image plane may be the same as those of the first lens E1, the second lens E2, the diaphragm STO, the third lens E3, the fourth lens E4, the fifth lens E5, the sixth lens E6, the optical filter and the image plane in Embodiment 1. Therefore, the table of the basic parameters of the optical camera lens assembly in this example is exactly the same as the basic parameters shown in Table 1 in Embodiment 1. To avoid the repeated description, the basic parameters will not be described in detail in this example. For details, reference may be made to the related content disclosed in Embodiment 1.

In this example, the high-order coefficients of the aspheric surfaces S1-S12 may be the same as those of the aspheric surfaces S1-S12 shown in Tables 3-1 and 3-2 in Embodiment 1. Therefore, to avoid the repeated description, the high-order coefficients of the aspheric surfaces S1-S12 will not be described in detail in this example. For details, reference may be made to the related content disclosed in Embodiment 1.

In this example, the numerical values of the optical technical parameters f, FOV, f56, DT11, Yc11 and Yc62 may be the same as those of f, FOV, f56, DT11, Yc11 and Yc62 in Embodiment 1. Therefore, to avoid the repeated description, the numerical values of the parameters will not be described in detail in this example. For details, reference may be made to the related content disclosed in Embodiment 1.

As shown in FIG. 2, the optical camera lens assembly may include seven separating pieces, which are respectively a first separating piece P1, a second separating piece P2, a third separating piece P3, a fourth separating piece P4, a fifth separating piece P5, a fifth auxiliary separating piece P5b and a fifth secondary auxiliary separating piece P5c. A lens barrel P0 can accommodate the first lens E1 to the sixth lens E6 and the first separating piece P1 to the fifth secondary auxiliary separating piece P5c.

Tables 4-1 and 4-2 are tables showing basic parameters of the separating pieces in the optical camera lens assembly of Embodiment 2. Here, the units of the parameters are millimeters (mm).

TABLE 4-1

| parameter | d1s | d3s | d4s | d5s | D5s | d0s | d0m |
|---|---|---|---|---|---|---|---|
| numerical value | 2.2600 | 2.1500 | 4.0028 | 5.0828 | 9.1600 | 5.5521 | 10.4600 |

TABLE 4-2

| parameter | EP12 | EP34 | EP45 | CP5 | L | d5bm | d5cm | D3s |
|---|---|---|---|---|---|---|---|---|
| numerical value | 0.5050 | 1.1741 | 0.6440 | 0.0220 | 6.0000 | 8.1639 | 7.4800 | 5.4348 |

It should be understood that, in this example, the structures an parameters of the separating pieces are only exemplarily listed, and the specific structures and actual parameters of the separating pieces are not explicitly defined. In actual production, the specific structures and actual parameters of the separating pieces can be set in any appropriate manner.

### Embodiment 3

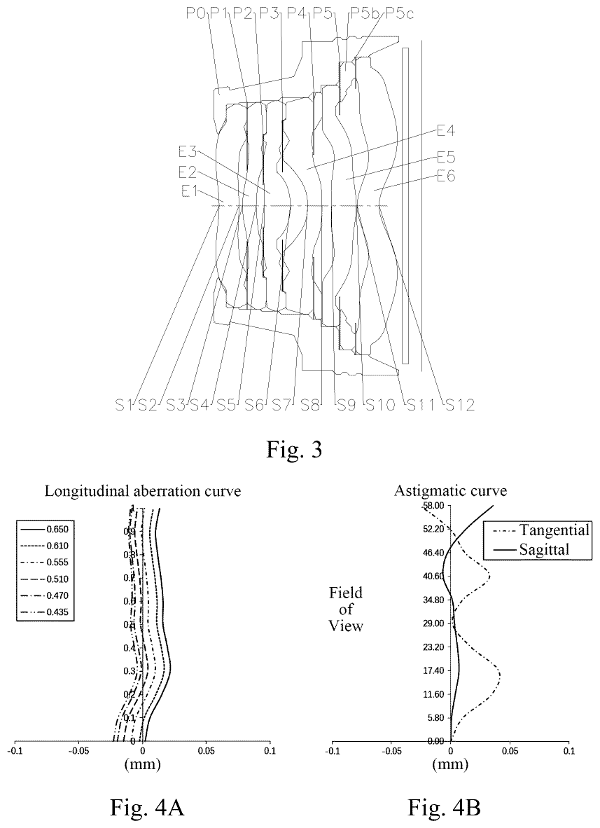

An optical camera lens assembly according to Embodiment 3 of the present disclosure is described below with reference to FIG. 3. FIG. 3 illustrates the optical camera lens assembly of Embodiment 3.

As shown in FIG. 3, the optical camera lens assembly includes, sequentially from an object side to an image side, a first lens E1, a second lens E2, a diaphragm STO (not shown), a third lens E3, a fourth lens E4, a fifth lens E5, a sixth lens E6, an optical filter (not shown) and an image plane (not shown).

In this example, the structures and parameters of the first lens E1, the second lens E2, the diaphragm STO, the third lens E3, the fourth lens E4, the fifth lens E5, the sixth lens E6, the optical filter and the image plane may be the same as those of the first lens E1, the second lens E2, the diaphragm STO, the third lens E3, the fourth lens E4, the fifth lens E5, the sixth lens E6, the optical filter and the image plane in Embodiment 1. Therefore, the table of the basic parameters of the optical camera lens assembly in this example is exactly the same as the basic parameters shown in Table 1 in Embodiment 1. To avoid the repeated description, the basic parameters will not be described in detail in this example. For details, reference may be made to the related content disclosed in Embodiment 1.

In this example, the high-order coefficients of the aspheric surfaces S1-S12 may be the same as those of the aspheric surfaces S1-S12 shown in Tables 3-1 and 3-2 in Embodiment 1. Therefore, to avoid the repeated description, the high-order coefficients of the aspheric surfaces S1-S12 will not be described in detail in this example. For details, reference may be made to the related content disclosed in Embodiment 1.

In this example, the numerical values of the optical technical parameters f, FOV, f56, DT11, Yc11 and Yc62 may be the same as those of f, FOV, f56, DT11, Yc11 and Yc62 in Embodiment 1. Therefore, to avoid the repeated description, the numerical values of the parameters will not be described in detail in this example. For details, reference may be made to the related content disclosed in Embodiment 1.

As shown in FIG. 3, the optical camera lens assembly may include seven separating pieces, which are respectively a first separating piece P1, a second separating piece P2, a third separating piece P3, a fourth separating piece P4, a fifth separating piece P5, a fifth auxiliary separating piece P5b and a fifth secondary auxiliary separating piece P5c. A lens barrel P0 can accommodate the first lens E1 to the sixth lens E6 and the first separating piece P1 to the fifth secondary auxiliary separating piece P5c.

Tables 5-1 and 5-2 are tables showing basic parameters of the separating pieces in the optical camera lens assembly of Embodiment 3. Here, the units of the parameters are millimeters (mm).

TABLE 5-1

| parameter | d1s | d3s | d4s | d5s | D5s | d0s | d0m |
|---|---|---|---|---|---|---|---|
| numerical value | 2.2600 | 2.1500 | 3.2700 | 5.8028 | 9.1600 | 5.5521 | 10.4600 |

TABLE 5-2

| parameter | EP12 | EP34 | EP45 | CP5 | L | d5bm | d5cm | D3s |
|---|---|---|---|---|---|---|---|---|
| numerical value | 0.5050 | 0.9878 | 0.8304 | 0.0220 | 6.0000 | 8.1657 | 7.4800 | 5.4348 |

It should be understood that, in this example, the structures an parameters of the separating pieces are only exemplarily listed, and the specific structures and actual parameters of the separating pieces are not explicitly defined. In actual production, the specific structures and actual parameters of the separating pieces can be set in any appropriate manner.

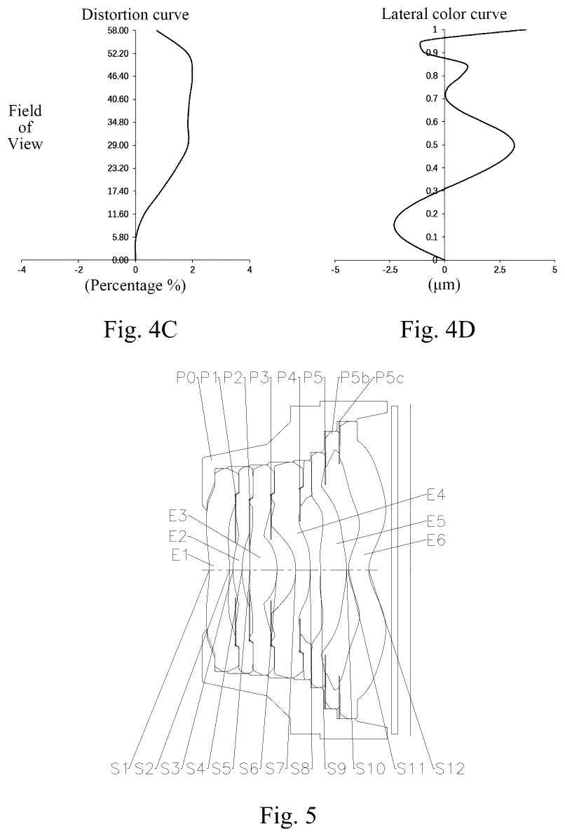

FIG. 4A illustrates longitudinal aberration curves of the optical camera lens assemblies of Embodiments 1-3, representing deviations of focal points of light of different wavelengths converged after passing through a lens assembly. FIG. 4B illustrates an astigmatic curve of the optical camera lens assemblies of Embodiments 1-3, representing a curvature of a tangential image plane and a curvature of a sagittal image plane. FIG. 4C illustrates a distortion curve of the optical camera lens assemblies of Embodiments 1-3, representing amounts of distortion corresponding to different fields-of-view. FIG. 4D illustrates a lateral color curve of the optical camera lens assemblies of Embodiments 1-3, representing deviations of different image heights on the image plane after light passes through a lens assembly. It can be seen from FIGS. 4A-4D that the optical camera lens assemblies given in Embodiments 1-3 can achieve a good imaging quality.

### Embodiment 4

An optical camera lens assembly according to Embodiment 4 of the present disclosure is described below with reference to FIG. 5. FIG. 5 illustrates the optical camera lens assembly of Embodiment 4.

As shown in FIG. 5, the optical camera lens assembly includes, sequentially from an object side to an image side, a first lens E1, a second lens E2, a diaphragm STO (not shown), a third lens E3, a fourth lens E4, a fifth lens E5, a sixth lens E6, an optical filter (not shown) and an image plane (not shown).

The first lens E1 has a positive refractive power, an object-side surface S1 of the first lens E1 is a concave surface, and an image-side surface S2 of the first lens E1 is a convex surface. The second lens E2 has a positive refractive power, an object-side surface S3 of the second lens E2 is a convex surface, and an image-side surface S4 of the second lens E2 is a concave surface. The third lens E3 has a positive refractive power, an object-side surface S5 of the third lens E3 is a convex surface, and an image-side surface S6 of the third lens E3 is a convex surface. The fourth lens E4 has a negative refractive power, an object-side surface S7 of the fourth lens E4 is a concave surface, and an image-side surface S8 of the fourth lens E4 is a convex surface. The fifth lens E5 has a positive refractive power, an object-side surface S9 of the fifth lens E5 is a concave surface, and an image-side surface S10 of the fifth lens E5 is a convex surface. The sixth lens E6 has a positive refractive power, an object-side surface S11 of the sixth lens E6 is a convex surface, and an image-side surface S12 of the sixth lens E6 is a concave surface. The optical filter has an object-side surface S13 and an image-side surface S14. Light from an object sequentially passes through the surfaces S1-S14, and finally forms an image on the image plane S15.

Table 6 is a table showing basic parameters of the optical camera lens assembly of Embodiment 4. Here, the units of a radius of curvature, a thickness/distance and a focal length are millimeters (mm).

TABLE 6

| | | | | material | | | |
|---|---|---|---|---|---|---|---|
| surface | surface | radius of | thickness/ | refractive | abbe | focal | conic |
| number | type | curvature | distance | index | number | length | coefficient |
| OBJ | spherical | infinite | | | | | |
| S1 | aspheric | −3.8798 | 0.6576 | 1.55 | 55.90 | 76.26 | −14.0941 |
| S2 | aspheric | −3.7612 | 0.1115 | | | | −2.8846 |
| S3 | aspheric | 2.6508 | 0.2951 | 1.68 | 19.20 | 304.86 | 0.2190 |
| S4 | aspheric | 2.5646 | 0.2026 | | | | −2.1592 |
| STO | spherical | infinite | 0.0516 | | | | |
| S5 | aspheric | 14.7314 | 0.8815 | 1.59 | 57.80 | 3.01 | 46.8010 |
| S6 | aspheric | −1.9801 | 0.6046 | | | | 0.7169 |
| S7 | aspheric | −1.6784 | 0.4694 | 1.68 | 19.20 | −4.41 | 0.0667 |
| S8 | aspheric | −4.2719 | 0.3321 | | | | −4.7007 |
| S9 | aspheric | −4.3704 | 0.8476 | 1.69 | 52.90 | 8.84 | −80.0000 |
| S10 | aspheric | −2.7520 | 0.0600 | | | | −0.1537 |
| S11 | aspheric | 1.1587 | 0.6614 | 1.69 | 53.00 | 12.72 | −3.4613 |
| S12 | aspheric | 1.0227 | 0.7314 | | | | −1.0086 |
| S13 | spherical | infinite | 0.2100 | 1.52 | 64.20 | | |
| S14 | spherical | infinite | 0.4084 | | | | |
| S15 | spherical | infinite | | | | | |

In this example, a total effective focal length f of the optical camera lens assembly is 3.05 mm, a maximal field-of-view FOV of the optical camera lens assembly is 118.0°, a combined focal length f56 of the fifth lens and the sixth lens is 4.40 mm, and a maximal effective radius DT11 of the object-side surface of the first lens is 2.07 mm. A distance along the direction perpendicular to the optical axis Yc11 between an inflection point on the object-side surface of the first lens and an intersection point of the object-side surface of the first lens and the optical axis is 1.47 mm, and a distance along the direction perpendicular to the optical axis Yc62 between an inflection point on the image-side surface of the sixth lens and an intersection point of the image-side surface of the sixth lens and the optical axis is 1.92 mm.

As shown in FIG. 5, the optical camera lens assembly may include seven separating pieces, which are respectively a first separating piece P1, a second separating piece P2, a third separating piece P3, a fourth separating piece P4, a fifth separating piece P5, a fifth auxiliary separating piece P5b and a fifth secondary auxiliary separating piece P5c. A lens barrel P0 can accommodate the first lens E1 to the sixth lens E6 and the first separating piece P1 to the fifth secondary auxiliary separating piece P5c.

Tables 7-1 and 7-2 are tables showing basic parameters of the separating pieces in the optical camera lens assembly of Embodiment 4. Here, the units of the parameters are millimeters (mm).

TABLE 7-1

| parameter | d1s | d3s | d4s | d5s | D5s | d0s | d0m |
|---|---|---|---|---|---|---|---|
| numerical value | 1.7631 | 1.9631 | 3.1231 | 5.4428 | 8.8600 | 4.2000 | 10.0600 |

TABLE 7-2

| parameter | EP12 | EP34 | EP45 | CP5 | L | d5bm | d5cm | D3s |
|---|---|---|---|---|---|---|---|---|
| numerical value | 0.4387 | 0.9167 | 0.8014 | 0.0220 | 6.0000 | 7.5597 | 6.7800 | 4.8300 |

It should be understood that, in this example, the structures and parameters of the separating pieces are only exemplarily listed, and the specific structures and actual parameters of the separating pieces are not explicitly defined. In actual production, the specific structures and actual parameters of the separating pieces can be set in any appropriate manner.

Tables 8-1 and 8-2 below show the high-order coefficients applicable to the aspheric surfaces S1-S12 in Embodiment 4.

TABLE 8-1

| surface | | | | | | | |
|---|---|---|---|---|---|---|---|
| number | A4 | A6 | A8 | A10 | A12 | A14 | A16 |
| S1 | 3.2496E−01 | −3.9359E−02 | 9.0774E−03 | −2.5458E−03 | 7.3944E−04 | −1.9966E−04 | 9.2341E−05 |
| S2 | 3.0386E−01 | −4.6860E−02 | 1.2514E−02 | −4.1077E−03 | 1.5626E−03 | −5.9148E−04 | 2.9234E−04 |
| S3 | −1.8164E−02 | −1.1231E−02 | 2.0671E−03 | −4.3353E−04 | 1.9375E−04 | −4.0303E−05 | 2.6542E−05 |
| S4 | −7.5606E−03 | −8.2431E−05 | 2.1893E−04 | 2.3974E−05 | 2.9419E−05 | 7.8554E−07 | 5.3054E−06 |
| S5 | −1.2476E−02 | −1.4353E−03 | −1.2570E−04 | 2.2247E−06 | 1.5316E−05 | 5.3319E−06 | 3.9864E−06 |
| S6 | −8.4318E−02 | −1.0151E−02 | −2.7441E−03 | −7.4535E−04 | −1.3414E−04 | −2.0521E−06 | 1.7693E−05 |
| S7 | −1.1798E−01 | 4.8242E−02 | 5.4065E−04 | −3.3206E−03 | 2.7587E−04 | 1.8240E−05 | −1.0009E−05 |
| S8 | −1.6779E−01 | 8.0656E−02 | 1.7209E−02 | −1.4732E−02 | 3.2977E−03 | −8.9275E−04 | 3.4191E−04 |
| S9 | 9.1642E−02 | −3.1933E−01 | 1.6084E−01 | −3.0402E−02 | 2.2616E−02 | −1.5577E−02 | 1.3552E−03 |
| S10 | 1.2209E+00 | −2.0558E−01 | 1.3242E−01 | −1.2980E−02 | 2.3548E−03 | 3.2667E−03 | −5.5935E−03 |
| S11 | −2.8070E+00 | 8.5883E−01 | −2.8017E−01 | 2.4599E−02 | 3.0174E−02 | −2.7402E−02 | 8.6132E−03 |
| S12 | −1.0298E+01 | 2.2747E+00 | −7.8885E−01 | 2.3650E−01 | −9.5270E−02 | 3.7756E−02 | −2.3264E−02 |

TABLE 8-2

| surface | | | | | | | |
|---|---|---|---|---|---|---|---|
| number | A18 | A20 | A22 | A24 | A26 | A28 | A30 |
| S1 | −9.5523E−06 | 1.5240E−06 | −4.8892E−06 | 8.3593E−07 | 2.6435E−06 | 1.3969E−07 | −1.3559E−06 |
| S2 | −1.0973E−04 | 4.6971E−05 | −2.4983E−05 | 1.0600E−05 | −3.3877E−06 | 4.7810E−07 | −2.6978E−08 |
| S3 | −1.0145E−07 | −6.6396E−07 | −1.9252E−06 | −1.6499E−06 | 8.2253E−07 | −5.4781E−07 | 2.8301E−07 |
| S4 | −7.6359E−07 | −1.9189E−06 | −1.4902E−06 | −2.5862E−07 | 2.7936E−07 | −3.1559E−08 | 8.8476E−09 |
| S5 | 9.7258E−07 | 9.1571E−07 | −7.3824E−07 | −7.1842E−07 | 2.4557E−08 | 4.8938E−07 | −1.5098E−07 |
| S6 | 1.4152E−05 | 9.2521E−06 | 7.5615E−06 | 4.9181E−06 | 1.3332E−06 | 2.7268E−07 | −7.6641E−07 |
| S7 | −2.4258E−05 | −2.1488E−05 | 8.5592E−06 | −9.3460E−06 | 3.8109E−06 | −2.5608E−06 | 2.2955E−06 |
| S8 | −1.9679E−04 | 1.6746E−05 | 2.2689E−05 | −1.9970E−05 | 2.5134E−05 | −1.6691E−05 | 3.8183E−06 |
| S9 | −1.4197E−03 | 2.2158E−03 | −4.0239E−04 | 8.5401E−05 | −2.2949E−04 | 4.9395E−05 | 1.0532E−05 |
| S10 | 4.8028E−03 | −7.6723E−04 | −4.8048E−04 | −1.1930E−04 | 3.8239E−05 | 1.2016E−04 | −3.0069E−05 |
| S11 | 1.7333E−03 | −3.7363E−03 | 2.8051E−03 | −2.8167E−04 | −8.0157E−04 | 7.2859E−04 | −2.2606E−04 |
| S12 | 1.0100E−02 | −6.2333E−03 | 4.2622E−03 | −1.5339E−03 | 9.7387E−04 | −5.0074E−04 | 3.0885E−04 |

### Embodiment 5

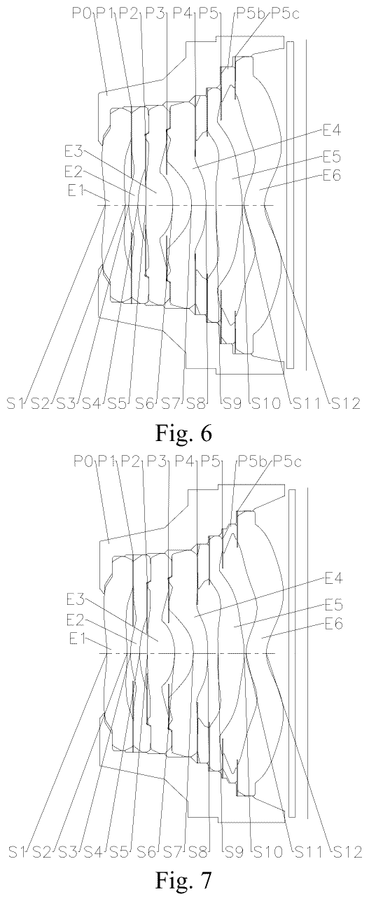

An optical camera lens assembly according to Embodiment 5 of the present disclosure is described below with reference to FIG. 6. FIG. 6 illustrates the optical camera lens assembly of Embodiment 5.

As shown in FIG. 6, the optical camera lens assembly includes, sequentially from an object side to an image side, a first lens E1, a second lens E2, a diaphragm STO (not shown), a third lens E3, a fourth lens E4, a fifth lens Ea, a sixth lens E6, an optical filter (not shown) and an image plane (not shown).

In this example, the structures and parameters of the first lens E1, the second lens E2, the diaphragm STO, the third lens E3, the fourth lens E4, the fifth lens E5, the sixth lens E6, the optical filter and the image plane may be the same as those of the first lens E1, the second lens E2, the diaphragm STO, the third lens E3, the fourth lens E4, the fifth lens E5, the sixth lens E6, the optical filter and the image plane in Embodiment 4. Therefore, the table of the basic parameters of the optical camera lens assembly in this example is exactly the same as the basic parameters shown in Table 6 in Embodiment 4. To avoid the repeated description, the basic parameters will not be described in detail in this example. For details, reference may be made to the related content disclosed in Embodiment 4.

In this example, the high-order coefficients of the aspheric surfaces S1-S12 may be the same as those of the aspheric surfaces S1-S12 shown in Tables 8-1 and 8-2 in Embodiment 4. Therefore, to avoid the repeated description, the high-order coefficients of the aspheric surfaces S1-S12 will not be described in detail in this example. For details, reference may be made to the related content disclosed in Embodiment 4.

In this example, the numerical values of the optical technical parameters f, FOV, f56, DT11, Yc11 and Yc62 may be the same as those of f, FOV, f56, DT11, Yc11 and Yc62 in Embodiment 4. Therefore, to avoid the repeated description, the numerical values of the parameters will not be described in detail in this example. For details, reference may be made to the related content disclosed in Embodiment 4.

As shown in FIG. 6, the optical camera lens assembly may include seven separating pieces, which are respectively a first separating piece P1, a second separating piece P2, a third separating piece P3, a fourth separating piece P4, a fifth separating piece P5, a fifth auxiliary separating piece P5b and a fifth secondary auxiliary separating piece P5c. A lens barrel P0 can accommodate the first lens E1 to the sixth lens E6 and the first separating piece P1 to the fifth secondary auxiliary separating piece P5c.

Tables 9-1 and 9-2 are tables showing basic parameters of the separating pieces in the optical camera lens assembly of Embodiment 5. Here, the units of the parameters are millimeters (mm).

TABLE 9-1

| parameter | d1s | d3s | d4s | d5s | D5s | d0s | d0m |
|---|---|---|---|---|---|---|---|
| numerical value | 1.7631 | 1.9631 | 3.1231 | 5.4428 | 8.8600 | 4.2000 | 10.0200 |

TABLE 9-2

| parameter | EP12 | EP34 | EP45 | CP5 | L | d5bm | d5cm | D3s |
|---|---|---|---|---|---|---|---|---|
| numerical value | 0.4387 | 0.9167 | 0.8014 | 0.0220 | 6.0372 | 7.5597 | 6.7800 | 4.8300 |

It should be understood that, in this example, the structures and parameters of the separating pieces are only exemplarily listed, and the specific structures and actual parameters of the separating pieces are not explicitly defined. In actual production, the specific structures and actual parameters of the separating pieces can be set in any appropriate manner.

### Embodiment 6

An optical camera lens assembly according to Embodiment 6 of the present disclosure is described below with reference to FIG. 7. FIG. 7 illustrates the optical camera lens assembly of Embodiment 6.

As shown in FIG. 7, the optical camera lens assembly includes, sequentially from an object side to an image side, a first lens E1, a second lens E2, a diaphragm STO (not shown), a third lens E3, a fourth lens E4, a fifth lens E5, a sixth lens E6, an optical filter (not shown) and an image plane (not shown).

In this example, the structures and parameters of the first lens E1, the second lens E2, the diaphragm STO, the third lens E3, the fourth lens E4, the fifth lens E5, the sixth lens E6, the optical filter and the image plane may be the same as those of the first lens E1, the second lens E2, the diaphragm STO, the third lens E3, the fourth lens E4, the fifth lens E5, the sixth lens E6, the optical filter and the image plane in Embodiment 4. Therefore, the table of the basic parameters of the optical camera lens assembly in this example is exactly the same as the basic parameters shown in Table 6 in Embodiment 4. To avoid the repeated description, the basic parameters will not be described in detail in this example. For details, reference may be made to the related content disclosed in Embodiment 4.

In this example, the high-order coefficients of the aspheric surfaces S1-S12 may be the same as those of the aspheric surfaces S1-S12 shown in Tables 8-1 and 8-2 in Embodiment 4. Therefore, to avoid the repeated description, the high-order coefficients of the aspheric surfaces S1-S12 will not be described in detail in this example. For details, reference may be made to the related content disclosed in Embodiment 4.

In this example, the numerical values of the optical technical parameters f, FOV, f56, DT1l, Yc11 and Yc62 may be the same as those of f, FOV, f56, DT11, Yc11 and Yc62 in Embodiment 4. Therefore, to avoid the repeated description, the numerical values of the parameters will not be described in detail in this example. For details, reference may be made to the related content disclosed in Embodiment 4.

As shown in FIG. 7, the optical camera lens assembly may include seven separating pieces, which are respectively a first separating piece P1, a second separating piece P2, a third separating piece P3, a fourth separating piece P4, a fifth separating piece P5, a fifth auxiliary separating piece P5b and a fifth secondary auxiliary separating piece P5c. A lens barrel P0 can accommodate the first lens E1 to the sixth lens E6 and the first separating piece P1 to the fifth secondary auxiliary separating piece P5c.

Tables 10-1 and 10-2 are tables showing basic parameters of the separating pieces in the optical camera lens assembly of Embodiment 6. Here, the units of the parameters are millimeters (mm).

TABLE 10-1

| parameter | d1s | d3s | d4s | d5s | D5s | d0s | d0m |
|---|---|---|---|---|---|---|---|
| numerical value | 1.7631 | 1.9631 | 3.1231 | 5.4428 | 7.9600 | 4.1079 | 10.0600 |

TABLE 10-2

| parameter | EP12 | EP34 | EP45 | CP5 | L | d5bm | d5cm | D3s |
|---|---|---|---|---|---|---|---|---|
| numerical value | 0.4387 | 0.9167 | 0.8014 | 0.0220 | 6.0000 | 7.3597 | 6.7800 | 4.8300 |

It should be understood that, in this example, the structures and parameters of the separating pieces are only exemplarily listed, and the specific structures and actual parameters of the separating pieces are not explicitly defined. In actual production, the specific structures and actual parameters of the separating pieces can be set in any appropriate manner.

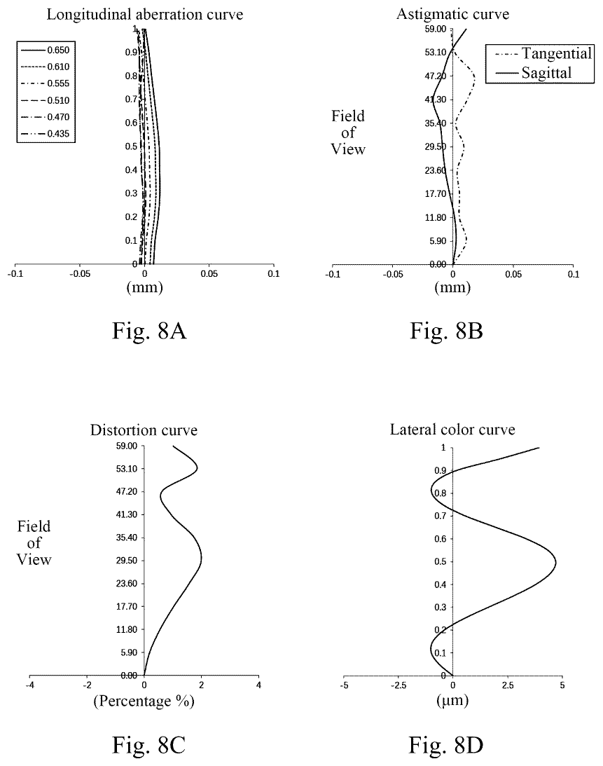

FIG. 8A illustrates longitudinal aberration curves of the optical camera lens assemblies of Embodiments 4-6, representing deviations of focal points of light of different wavelengths converged after passing through a lens assembly. FIG. 8B illustrates an astigmatic curve of the optical camera lens assemblies of Embodiments 4-6, representing a curvature of a tangential image plane and a curvature of a sagittal image plane. FIG. 8C illustrates a distortion curve of the optical camera lens assemblies of Embodiments 4-6, representing amounts of distortion corresponding to different fields-of-view. FIG. 8D illustrates a lateral color curve of the optical camera lens assemblies of Embodiments 4-6, representing deviations of different image heights on the image plane after light passes through a lens assembly. It can be seen from FIGS. 8A-8D that the optical camera lens assemblies given in Embodiments 4-6 can achieve a good imaging quality.

### Embodiment 7

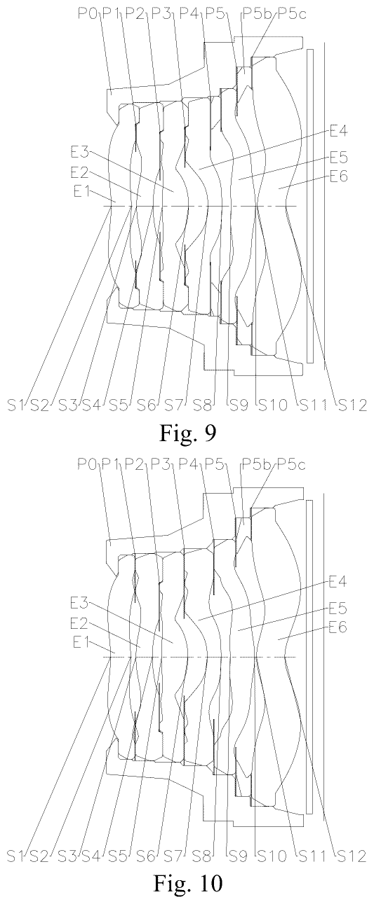

An optical camera lens assembly according to Embodiment 7 of the present disclosure is described below with reference to FIG. 9. FIG. 9 illustrates the optical camera lens assembly of Embodiment 7.

As shown in FIG. 9, the optical camera lens assembly includes, sequentially from an object side to an image side, a first lens E1, a second lens E2, a diaphragm STO (not shown), a third lens E3, a fourth lens E4, a fifth lens E5, a sixth lens E6, an optical filter (not shown) and an image plane (not shown).

The first lens E1 has a positive refractive power, an object-side surface S1 of the first lens E1 is a concave surface, and an image-side surface S2 of the first lens E1 is a convex surface. The second lens E2 has a positive refractive power, an object-side surface S3 of the second lens E2 is a convex surface, and an image-side surface S4 of the second lens E2 is a concave surface. The third lens E3 has a positive refractive power, an object-side surface S5 of the third lens E3 is a convex surface, and an image-side surface S6 of the third lens E3 is a convex surface. The fourth lens E4 has a negative refractive power, an object-side surface S7 of the fourth lens E4 is a concave surface, and an image-side surface S8 of the fourth lens E4 is a convex surface. The fifth lens E5 has a positive refractive power, an object-side surface S9 of the fifth lens E5 is a concave surface, and an image-side surface S10 of the fifth lens E5 is a convex surface. The sixth lens E6 has a positive refractive power, an object-side surface S11 of the sixth lens E6 is a convex surface, and an image-side surface S12 of the sixth lens E6 is a concave surface. The optical filter has an object-side surface S13 and an image-side surface S14. Light from an object sequentially passes through the surfaces S1-S14, and finally forms an image on the image plane S15.

Table 11 is a table showing basic parameters of the optical camera lens assembly of Embodiment 7. Here, the units of a radius of curvature, a thickness/distance and a focal length are millimeters (mm).

TABLE 11

| | | | | material | | | |
|---|---|---|---|---|---|---|---|
| surface | surface | radius of | thickness/ | refractive | abbe | focal | conic |
| number | type | curvature | distance | index | number | length | coefficient |
| OBJ | spherical | infinite | | | | | |
| S1 | aspheric | −4.0000 | 0.6500 | 1.55 | 55.90 | 61.35 | −13.6756 |
| S2 | aspheric | −3.7781 | 0.1723 | | | | −7.2492 |
| S3 | aspheric | 3.4149 | 0.5300 | 1.68 | 19.20 | 210.50 | 0.8560 |
| S4 | aspheric | 3.2796 | 0.2406 | | | | −2.0528 |
| STO | spherical | infinite | 0.0615 | | | | |
| S5 | aspheric | 9.6604 | 0.8500 | 1.60 | 57.10 | 3.19 | 86.0169 |
| S6 | aspheric | −2.3192 | 0.6276 | | | | −0.1704 |
| S7 | aspheric | −2.1571 | 0.4500 | 1.68 | 19.20 | −5.31 | 0.3984 |
| S8 | aspheric | −5.8408 | 0.2949 | | | | 1.5156 |
| S9 | aspheric | −3.7461 | 0.7909 | 1.58 | 36.50 | 15.07 | −80.0000 |
| S10 | aspheric | −2.8332 | 0.0606 | | | | −0.1580 |
| S11 | aspheric | 1.5497 | 0.9160 | 1.69 | 53.10 | 19.99 | −20.5675 |
| S12 | aspheric | 1.3252 | 0.6881 | | | | −0.9902 |
| S13 | spherical | infinite | 0.2100 | 1.52 | 64.20 | | |
| S14 | spherical | infinite | 0.3652 | | | | |
| S15 | spherical | infinite | | | | | |

In this example, a total effective focal length f of the optical camera lens assembly is 3.44 mm, a maximal field-of-view FOV of the optical camera lens assembly is 110.80, a combined focal length f56 of the fifth lens and the sixth lens is 7.21 mm, and a maximal effective radius DT11 of the object-side surface of the first lens is 2.53 mm. A distance along the direction perpendicular to the optical axis Yc11 between an inflection point on the object-side surface of the first lens and an intersection point of the object-side surface of the first lens and the optical axis is 1.38 mm, and a distance along the direction perpendicular to the optical axis Yc62 between an inflection point on the image-side surface of the sixth lens and an intersection point of the image-side surface of the sixth lens and the optical axis is 2.17 mm.

As shown in FIG. 9, the optical camera lens assembly may include seven separating pieces, which are respectively a first separating piece P1, a second separating piece P2, a third separating piece P3, a fourth separating piece P4, a fifth separating piece P5, a fifth auxiliary separating piece P5b and a fifth secondary auxiliary separating piece P5c. A lens barrel P0 can accommodate the first lens E1 to the sixth lens E6 and the first separating piece P1 to the fifth secondary auxiliary separating piece P5c.

Tables 12-1 and 12-2 are tables showing basic parameters of the separating pieces in the optical camera lens assembly of Embodiment 7. Here, the units of the parameters are millimeters (mm).

TABLE 12-1

| parameter | d1s | d3s | d4s | d5s | D5s | d0s | d0m |
|---|---|---|---|---|---|---|---|
| numerical value | 3.4700 | 2.4600 | 3.5813 | 5.7428 | 8.8600 | 6.0094 | 10.0600 |

TABLE 12-2

| parameter | EP12 | EP34 | EP45 | CP5 | L | d5bm | d5cm | D3s |
|---|---|---|---|---|---|---|---|---|
| numerical value | 0.7678 | 0.8148 | 0.8248 | 0.0220 | 6.3379 | 7.5597 | 7.4200 | 5.0300 |

It should be understood that, in this example, the structures and parameters of the separating pieces are only exemplarily listed, and the specific structures and actual parameters of the separating pieces are not explicitly defined. In actual production, the specific structures and actual parameters of the separating pieces can be set in any appropriate manner.

Tables 13-1 and 13-2 below show the high-order coefficients applicable to the aspheric surfaces S1-S12 in Embodiment 7.

TABLE 13-1

| surface | | | | | | | |
|---|---|---|---|---|---|---|---|
| number | A4 | A6 | A8 | A10 | A12 | A14 | A16 |
| S1 | 6.9281E−01 | −6.7591E−02 | 2.0980E−02 | −4.0558E−03 | 1.9757E−03 | −4.0626E−04 | 2.0580E−04 |
| S2 | 5.3869E−01 | −1.0063E−01 | 2.6908E−02 | −7.4998E−03 | 3.1750E−03 | −1.3028E−03 | 5.7556E−04 |
| S3 | −8.6303E−02 | −2.3036E−02 | 6.4270E−03 | −3.9494E−04 | 2.4828E−04 | −1.6543E−04 | 3.6888E−05 |
| S4 | −1.5015E−02 | 2.8629E−03 | 1.6263E−03 | 4.5357E−04 | 1.4790E−04 | 4.0243E−05 | 1.6733E−05 |
| S5 | −2.6294E−02 | −2.2371E−03 | −2.9329E−05 | 2.8860E−05 | −6.6755E−06 | 5.2458E−07 | −4.4747E−06 |
| S6 | −8.1332E−02 | −2.8982E−03 | 5.5559E−04 | 2.1421E−04 | 1.6886E−04 | 1.5773E−05 | 4.3309E−05 |
| S7 | −1.9970E−01 | 5.6343E−02 | 2.8564E−03 | −3.8500E−03 | 1.8535E−04 | −1.9156E−04 | 1.2782E−04 |
| S8 | −2.2212E−01 | 9.5475E−02 | 1.9150E−02 | −1.8557E−02 | 4.1371E−03 | −1.2541E−03 | 8.8128E−04 |
| S9 | 2.8561E−02 | −2.6819E−01 | 2.0581E−01 | −4.3414E−02 | 1.4318E−02 | −1.9759E−02 | 4.0449E−03 |
| S10 | 1.5997E+00 | −2.4729E−01 | 1.9081E−01 | −2.2522E−02 | 8.5952E−03 | 5.3494E−03 | −6.8400E−03 |
| S11 | −1.3484E+00 | 4.5462E−01 | −8.2564E−02 | −5.1556E−02 | 7.6137E−02 | −6.3451E−02 | 3.6415E−02 |
| S12 | −9.5616E+00 | 1.9531E+00 | −5.9689E−01 | 2.2004E−01 | −8.5830E−02 | 4.0675E−02 | −2.4540E−02 |

TABLE 13-2

| surface | | | | | | | |
|---|---|---|---|---|---|---|---|
| number | A18 | A20 | A22 | A24 | A26 | A28 | A30 |
| S1 | −3.6246E−05 | 6.8756E−06 | −1.4543E−05 | −8.1800E−06 | −1.4764E−05 | 1.5292E−05 | 7.6611E−06 |
| S2 | −2.4874E−04 | 1.0419E−04 | −6.0437E−05 | 2.5710E−05 | −6.5629E−06 | 2.5312E−05 | −1.1279E−05 |
| S3 | −1.1694E−05 | 3.1680E−07 | −6.8939E−06 | 2.6962E−07 | 7.3443E−07 | 1.9036E−06 | −6.1089E−07 |
| S4 | 3.5207E−06 | 1.4871E−06 | −2.0841E−07 | −3.0942E−07 | −1.6621E−06 | −2.0351E−06 | 8.3148E−07 |
| S5 | 1.3404E−06 | −1.7068E−06 | 6.6686E−07 | −1.9647E−06 | −9.1504E−07 | −4.8082E−07 | 4.9742E−07 |
| S6 | −8.3672E−06 | 1.0362E−05 | −6.0249E−06 | 5.1422E−06 | −2.8564E−06 | 1.6942E−06 | −5.4468E−07 |
| S7 | −1.1298E−04 | 1.1914E−06 | −2.3627E−05 | −2.7477E−07 | −3.3718E−06 | −3.1869E−06 | 5.4045E−06 |
| S8 | −4.9775E−04 | 1.7707E−04 | −1.1342E−04 | 6.8137E−05 | −2.4481E−05 | 1.6808E−05 | −5.1135E−06 |
| S9 | 7.5743E−04 | 2.4078E−03 | −1.1714E−03 | −2.0931E−04 | −1.7185E−04 | 2.5667E−04 | −5.7699E−05 |
| S10 | 4.6354E−03 | −1.1255E−03 | −5.3051E−04 | −1.4848E−04 | −2.0446E−04 | 4.5185E−04 | −1.0707E−04 |
| S11 | −1.8905E−02 | 7.5548E−03 | −6.8117E−03 | 4.6683E−03 | −5.9545E−03 | 3.0783E−03 | −4.6102E−03 |
| S12 | 1.0522E−02 | −6.2808E−03 | 3.6902E−03 | −1.4872E−03 | 8.5339E−04 | −5.0938E−04 | 2.1457E−04 |

### Embodiment 8

An optical camera lens assembly according to Embodiment 8 of the present disclosure is described below with reference to FIG. 10. FIG. 10 illustrates the optical camera lens assembly of Embodiment 8.

As shown in FIG. 10, the optical camera lens assembly includes, sequentially from an object side to an image side, a first lens E1, a second lens E2, a diaphragm STO (not shown), a third lens E3, a fourth lens E4, a fifth lens E5, a sixth lens E6, an optical filter (not shown) and an image plane (not shown).

In this example, the structures and parameters of the first lens E1, the second lens E2, the diaphragm STO, the third lens E3, the fourth lens E4, the fifth lens E5, the sixth lens E6, the optical filter and the image plane may be the same as those of the first lens E1, the second lens E2, the diaphragm STO, the third lens E3, the fourth lens E4, the fifth lens E5, the sixth lens E6, the optical filter and the image plane in Embodiment 7. Therefore, the table of the basic parameters of the optical camera lens assembly in this example is exactly the same as the basic parameters shown in Table 11 in Embodiment 7. To avoid the repeated description, the basic parameters will not be described in detail in this example. For details, reference may be made to the related content disclosed in Embodiment 7.

In this example, the high-order coefficients of the aspheric surfaces S1-S12 may be the same as those of the aspheric surfaces S1-S12 shown in Tables 13-1 and 13-2 in Embodiment 7. Therefore, to avoid the repeated description, the high-order coefficients of the aspheric surfaces S1-S12 will not be described in detail in this example. For details, reference may be made to the related content disclosed in Embodiment 7.

In this example, the numerical values of the optical technical parameters f, FOV, f56, DT11, Yc11 and Yc62 may be the same as those of f, FOV, f56, DT11, Yc11 and Yc62 in Embodiment 7. Therefore, to avoid the repeated description, the numerical values of the parameters will not be described in detail in this example. For details, reference may be made to the related content disclosed in Embodiment 7.

As shown in FIG. 10, the optical camera lens assembly may include seven separating pieces, which are respectively a first separating piece P1, a second separating piece P2, a third separating piece P3, a fourth separating piece P4, a fifth separating piece P5, a fifth auxiliary separating piece P5b and a fifth secondary auxiliary separating piece P5c. A lens barrel P0 can accommodate the first lens E1 to the sixth lens E6 and the first separating piece P1 to the fifth secondary auxiliary separating piece P5c.

Tables 14-1 and 14-2 are tables showing basic parameters of the separating pieces in the optical camera lens assembly of Embodiment 8. Here, the units of the parameters are millimeters (mm).

TABLE 14-1

| parameter | d1s | d3s | d4s | d5s | D5s | d0s | d0m |
|---|---|---|---|---|---|---|---|
| numerical value | 3.4700 | 2.4600 | 3.9613 | 5.7428 | 8.8600 | 6.0676 | 10.0200 |

TABLE 14-2

| parameter | EP12 | EP34 | EP45 | CP5 | L | d5bm | d5cm | D3s |
|---|---|---|---|---|---|---|---|---|
| numerical value | 0.7678 | 0.9464 | 0.6931 | 0.0220 | 6.3922 | 7.5597 | 7.4200 | 6.9000 |

It should be understood that, in this example, the structures and parameters of the separating pieces are only exemplarily listed, and the specific structures and actual parameters of the separating pieces are not explicitly defined. In actual production, the specific structures and actual parameters of the separating pieces can be set in any appropriate manner.

### Embodiment 9

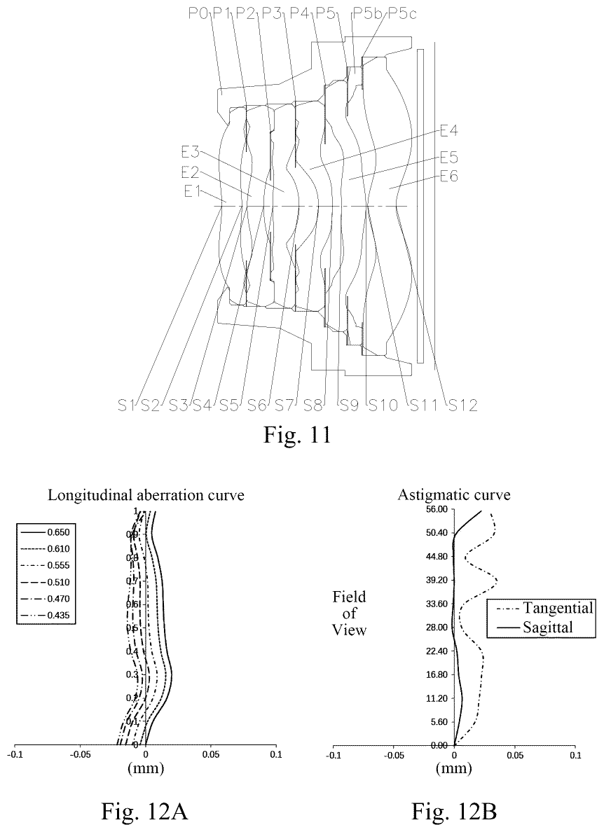

An optical camera lens assembly according to Embodiment 9 of the present disclosure is described below with reference to FIG. 11. FIG. 11 illustrates the optical camera lens assembly of Embodiment 9.

As shown in FIG. 11, the optical camera lens assembly includes, sequentially from an object side to an image side, a first lens E1, a second lens E2, a diaphragm STO (not shown), a third lens E3, a fourth lens E4, a fifth lens E5, a sixth lens E6, an optical filter (not shown) and an image plane (not shown).

In this example, the structures and parameters of the first lens E1, the second lens E2, the diaphragm STO, the third lens E3, the fourth lens E4, the fifth lens E5, the sixth lens E6, the optical filter and the image plane may be the same as those of the first lens E1, the second lens E2, the diaphragm STO, the third lens E3, the fourth lens E4, the fifth lens E5, the sixth lens E6, the optical filter and the image plane in Embodiment 7. Therefore, the table of the basic parameters of the optical camera lens assembly in this example is exactly the same as the basic parameters shown in Table 11 in Embodiment 7. To avoid the repeated description, the basic parameters will not be described in detail in this example. For details, reference may be made to the related content disclosed in Embodiment 7.

In this example, the high-order coefficients of the aspheric surfaces S1-S12 may be the same as those of the aspheric surfaces S1-S12 shown in Tables 13-1 and 13-2 in Embodiment 7. Therefore, to avoid the repeated description, the high-order coefficients of the aspheric surfaces S1-S12 will not be described in detail in this example. For details, reference may be made to the related content disclosed in Embodiment 7.

In this example, the numerical values of the optical technical parameters f, FOV, f56, DT11, Yc11 and Yc62 may be the same as those of f, FOV, f56, DT11, Yc11 and Yc62 in Embodiment 7. Therefore, to avoid the repeated description, the numerical values of the parameters will not be described in detail in this example. For details, reference may be made to the related content disclosed in Embodiment 7.

As shown in FIG. 11, the optical camera lens assembly may include seven separating pieces, which are respectively a first separating piece P1, a second separating piece P2, a third separating piece P3, a fourth separating piece P4, a fifth separating piece P5, a fifth auxiliary separating piece P5b and a fifth secondary auxiliary separating piece P5c. A lens barrel P0 can accommodate the first lens E1 to the sixth lens E6 and the first separating piece P1 to the fifth secondary auxiliary separating piece P5c.

Tables 15-1 and 15-2 are tables showing basic parameters of the separating pieces in the optical camera lens assembly of Embodiment 9. Here, the units of the parameters are millimeters (mm).

TABLE 15-1

| parameter | d1s | d3s | d4s | d5s | D5s | d0s | d0m |
|---|---|---|---|---|---|---|---|
| numerical value | 3.4700 | 2.4600 | 3.9613 | 5.7428 | 8.8600 | 6.0676 | 10.0600 |

TABLE 15-2

| parameter | EP12 | EP34 | EP45 | CP5 | L | d5bm | d5cm | D3s |
|---|---|---|---|---|---|---|---|---|
| numerical value | 0.7678 | 0.9464 | 0.6931 | 0.0220 | 6.3000 | 7.7574 | 7.4200 | 6.7000 |

It should be understood that, in is example, the structures an parameters of the separating pieces are only exemplarily listed, and the specific structures and actual parameters of the separating pieces are not explicitly defined. In actual production, the specific structures and actual parameters of the separating pieces can be set in any appropriate manner.

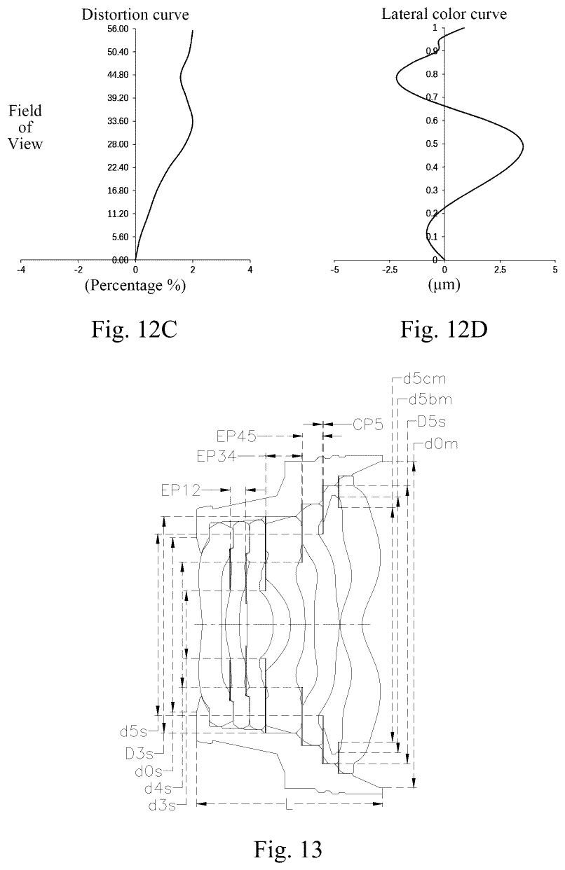

FIG. 12A illustrates longitudinal aberration curves of the optical camera lens assemblies of Embodiments 7-9, representing deviations of focal points of light of different wavelengths converged after passing through a lens assembly. FIG. 12B illustrates an astigmatic curve of the optical camera lens assemblies of Embodiments 7-9, representing a curvature of a tangential image plane and a curvature of a sagittal image plane. FIG. 12C illustrates a distortion curve of the optical camera lens assemblies of Embodiments 7-9, representing amounts of distortion corresponding to different fields-of-view. FIG. 12D illustrates a lateral color curve of the optical camera lens assemblies of Embodiments 7-9, representing deviations of different image heights on the image plane after light passes through a lens assembly. It can be seen from FIGS. 12A-12D that the optical camera lens assemblies given in Embodiments 7-9 can achieve a good imaging quality.

In summary, Embodiments 1-9 respectively satisfy the relationships shown in Tables 16-1, 16-2 and 16-3.

TABLE 16-1

| Conditional expression/ | Embodiment | Embodiment | Embodiment |
|---|---|---|---|
| Embodiment | 1 | 2 | 3 |
| (EP45 + CP5)/T56 | 24.46 | 24.46 | 31.31 |
| d5s/f5 | 0.61 | 0.53 | 0.61 |
| d5s/f6 | 0.38 | 0.33 | 0.38 |
| f2/f | 7.36 | 7.36 | 7.36 |
| EP12/f2 − EP12/R4 | −0.11 | −0.11 | −0.11 |
| f3/f4 | −0.72 | −0.72 | −0.72 |
| d3s/f3 − D3s/f4 | 2.27 | 1.93 | 1.93 |
| f4/(EP34 + CT4) | −2.66 | −2.66 | −3.00 |
| (N4 + N5)/2 | 1.66 | 1.66 | 1.66 |
| d4s/\|(f4 + f5)\| | 0.77 | 0.77 | 0.63 |
| L/(CT5 + T56 + CT6) | 3.90 | 3.88 | 3.88 |
| D5s/\|R8/R9\| (mm) | 5.90 | 6.10 | 6.10 |
| R9/R12 | −4.14 | −4.14 | −4.14 |
| f56/(EP45 + T56) | 7.46 | 7.46 | 5.84 |
| d0s/R1 | −1.54 | −1.54 | −1.54 |
| d0s/d0m | 0.53 | 0.53 | 0.53 |
| (DT11 − Yc11)/d1s | 0.35 | 0.35 | 0.35 |
| d5s/Yc62 | 2.73 | 2.39 | 2.73 |
| (d5bm + d5cm)/f6 | 1.02 | 1.02 | 1.02 |

TABLE 16-2

| Conditional expression/ | Embodiment | Embodiment | Embodiment |
|---|---|---|---|
| Embodiment | 4 | 5 | 6 |
| (EP45 + CP5)/T56 | 13.72 | 13.72 | 13.72 |
| d5s/f5 | 0.62 | 0.62 | 0.62 |
| d5s/f6 | 0.43 | 0.43 | 0.43 |
| f2/f | 100.09 | 100.09 | 100.09 |
| EP12/f2 − EP12/R4 | −0.17 | −0.17 | −0.17 |
| f3/f4 | −0.68 | −0.68 | −0.68 |
| d3s/f3 − D3s/f4 | 1.75 | 1.75 | 1.75 |
| f4/(EP34 + CT4) | −3.18 | −3.18 | −3.18 |
| (N4 + N5)/2 | 1.69 | 1.69 | 1.69 |
| d4s/\|(f4 + f5)\| | 0.70 | 0.70 | 0.70 |
| L/(CT5 + T56 + CT6) | 3.82 | 3.85 | 3.82 |
| D5s/\|R8/R9\| (mm) | 9.06 | 9.06 | 8.14 |
| R9/R12 | −4.27 | −4.27 | −4.27 |
| f56/(EP45 + T56) | 5.11 | 5.11 | 5.11 |
| d0s/R1 | −1.08 | −1.08 | −1.06 |
| d0s/d0m | 0.42 | 0.42 | 0.41 |
| (DT11 − Yc11)/d1s | 0.34 | 0.34 | 0.34 |
| d5s/Yc62 | 2.84 | 2.84 | 2.84 |
| (d5bm + d5cm)/f6 | 1.13 | 1.13 | 1.11 |

TABLE 16-3

| Conditional expression/ | Embodiment | Embodiment | Embodiment |
|---|---|---|---|
| Embodiment | 7 | 8 | 9 |
| (EP45 + CP5)/T56 | 13.98 | 11.81 | 11.81 |
| d5s/f5 | 0.38 | 0.38 | 0.38 |
| d5s/f6 | 0.29 | 0.29 | 0.29 |
| f2/f | 61.19 | 61.19 | 61.19 |
| EP12/f2 − EP12/R4 | −0.23 | −0.23 | −0.23 |
| f3/f4 | −0.60 | −0.60 | −0.60 |
| d3s/f3 − D3s/f4 | 1.72 | 2.07 | 2.03 |
| f4/(EP34 + CT4) | −4.20 | −3.81 | −3.81 |
| (N4 + N5)/2 | 1.63 | 1.63 | 1.63 |
| d4s/\|(f4 + f5)\| | 0.37 | 0.41 | 0.41 |
| L/(CT5 + T56 + CT6) | 3.59 | 3.62 | 3.56 |
| D5s/R8/R9\| (mm) | 5.68 | 5.68 | 5.68 |
| R9/R12 | −2.83 | −2.83 | −2.83 |
| f56/(EP45 + T56) | 8.14 | 9.56 | 9.56 |
| d0s/R1 | −1.50 | −1.52 | −1.52 |
| d0s/d0m | 0.60 | 0.61 | 0.60 |
| (DT11 − Yc11)/d1s | 0.33 | 0.33 | 0.33 |
| d5s/Yc62 | 2.65 | 2.65 | 2.65 |
| (d5bm + d5cm)/f6 | 0.75 | 0.75 | 0.76 |

Embodiments of the present disclosure further provides an imaging apparatus having an electronic photosensitive element which may be a charge coupled device (CCD) or complementary metal-oxide semiconductor element (CMOS). The imaging apparatus may be an independent imaging device such as a digital camera, or may be an imaging module integrated in a mobile electronic device such as a mobile phone. The imaging apparatus is equipped with the optical camera lens assembly described above.

The foregoing is only a description for preferred embodiments of the present disclosure and the applied technical principles. It should be appreciated by those skilled in the art that the inventive scope of the present disclosure is not limited to the technical solution formed by the particular combination of the above technical features. The inventive scope should also cover other technical solutions formed by any combination of the above technical features or equivalent features thereof without departing from the concept of the present disclosure, for example, technical solutions formed by replacing the features disclosed in embodiments of the present disclosure with (but not limited to) technical features with similar functions.

What is claimed is:

1. An optical camera lens assembly, comprising:
a lens group, composed of six lenses having refractive powers, and comprising, sequentially along an optical axis from an object side to an image side, a first lens, a second lens, a third lens, a fourth lens, a fifth lens and a sixth lens that have refractive powers;
a plurality of separating pieces, comprising:
a first separating piece, positioned on an image side of the first lens and partially in contact with an image-side surface of the first lens;
a second separating piece, positioned on an image side of the second lens and partially in contact with an image-side surface of the second lens;
a third separating piece, positioned on an image side of the third lens and partially in contact with an image-side surface of the third lens;
a fourth separating piece, positioned on an image side of the fourth lens and partially in contact with an image-side surface of the fourth lens; and
a fifth separating piece, positioned on an image side of the fifth lens and partially in contact with an image-side surface of the fifth lens; and
a lens barrel, used to accommodate the lens group and the plurality of separating pieces,
wherein the optical camera lens assembly satisfies: 10<(EP45+CP5)/T56<40.0, 0<d5s/f5<1.0 and 0<d5s/f6<1.0, wherein EP45 is a spacing distance from an image-side surface of the fourth separating piece to an object-side surface of the fifth separating piece in a direction of the optical axis, CP5 is a maximal thickness of the fifth separating piece along the direction of the optical axis, T56 is an air spacing between the fifth lens and the sixth lens on the optical axis, f5 is an effective focal length of the fifth lens, f6 is an effective focal length of the sixth lens, and d5s is an inner diameter of the object-side surface of the fifth separating piece.

2. The optical camera lens assembly according to claim 1, satisfying: 0<f2/f<110 and −1.0<EP12/f2−EP12/R4<0, wherein f2 is an effective focal length of the second lens, f is a total effective focal length of the optical camera lens assembly, EP12 is a spacing distance from an image-side surface of the first separating piece to an object-side surface of the second separating piece in the direction of the optical axis, and R4 is a radius of curvature of the image-side surface of the second lens.

3. The optical camera lens assembly according to claim 1, satisfying: −1.0<f3/f4<0 and 1.5<d3s/f3−D3s/f4<2.5, wherein f3 is an effective focal length of the third lens, f4 is an effective focal length of the fourth lens, d3s is an inner diameter of an object-side surface of the third separating piece, and D3s is an outer diameter of the object-side surface of the third separating piece.

4. The optical camera lens assembly according to claim 1, satisfying: −5.0<f4/(EP34+CT4)<−2.0, wherein f4 is an effective focal length of the fourth lens, EP34 is a spacing distance from an image-side surface of the third separating piece to an object-side surface of the fourth separating piece in the direction of the optical axis, and CT4 is a center thickness of the fourth lens on the optical axis.

5. The optical camera lens assembly according to claim 1, satisfying: 1.62<(N4+N5)/2<1.80 and 0<d4s/|(f4+f5)|<1.0, wherein N4 is a refractive index of the fourth lens, N5 is a refractive index of the fifth lens, d4s is an inner diameter of an object-side surface of the fourth separating piece, and f4 is an effective focal length of the fourth lens.

6. The optical camera lens assembly according to claim 1, satisfying: 3.0<L/(CT5+T56+CT6)<4.0, wherein L is a spacing distance from an object-side end of the lens barrel to an image-side end of the lens barrel in the direction of the optical axis, CT5 is a center thickness of the fifth lens on the optical axis, and CT6 is a center thickness of the sixth lens on the optical axis.

7. The optical camera lens assembly according to claim 1, satisfying: 5 mm<D5s/|R8/R9|<10.0 mm, wherein D5s is an outer diameter of the object-side surface of the fifth separating piece, R8 is a radius of curvature of the image-side surface of the fourth lens, and R9 is a radius of curvature of an object-side surface of the fifth lens.

8. The optical camera lens assembly according to claim 1, satisfying: −10.0<R9/R12<−1.0 and 4.0<f56/(EP45+T56)<10.0, wherein R9 is a radius of curvature of an object-side surface of the fifth lens, R12 is a radius of curvature of an image-side surface of the sixth lens, and f56 is a combined focal length of the fifth lens and the sixth lens.

9. The optical camera lens assembly according to claim 1, satisfying: −2.0<d0s/R1<−0.5, wherein R1 is a radius of curvature of an object-side surface of the first lens, and d0s is an inner diameter of an object-side end of the lens barrel.

10. The optical camera lens assembly according to claim 1, satisfying: 110.0°<FOV<120.0° and 0.3<d0s/d0m<0.7, wherein FOV is a maximal field-of-view of the optical camera lens assembly, d0s is an inner diameter of an object-side end of the lens barrel, and d0m is an inner diameter of an image-side end of the lens barrel.

11. The optical camera lens assembly according to claim 1, wherein a maximal diameter of any lens in the first lens to the fourth lens is smaller than a maximal diameter of the fifth lens.

12. The optical camera lens assembly according to claim 1, wherein surfaces of at least one of the first lens or the sixth lens have at least one inflection point.

13. The optical camera lens assembly according to claim 12, wherein the surfaces of the first lens have at least one inflection point, and the optical camera lens assembly satisfies: 0<(DT11-Yc11)/d1s<0.6, wherein DT11 is a maximal effective radius of the object-side surface of the first lens, Yc11 is a distance along a direction perpendicular to the optical axis between an inflection point on the object-side surface of the first lens and an intersection point of the object-side surface of the first lens and the optical axis, and d1s is an inner diameter of an object-side surface of the first separating piece.

14. The optical camera lens assembly according to claim 12, wherein the surfaces of the sixth lens have at least one inflection point, and the optical camera lens assembly satisfies: 2.0<d5s/Yc62<3.0, wherein Yc62 is a distance along a direction perpendicular to the optical axis between an inflection point on the image-side surface of the sixth lens and an intersection point of the image-side surface of the sixth lens and the optical axis.

15. The optical camera lens assembly according to claim 1, wherein the plurality of separating pieces further comprise: a fifth auxiliary separating piece, positioned on an image side of the fifth separating piece and partially in contact with an image-side surface of the fifth separating piece; and a fifth secondary auxiliary separating piece, positioned on an image side of the fifth auxiliary separating piece and partially in contact with an image-side surface of the fifth auxiliary separating piece, and
the optical camera lens assembly satisfies: 0<(d5bm+d5 cm)/f6<2.0, wherein d5bm is an inner diameter of the image-side surface of the fifth auxiliary separating piece, and d5 cm is an inner diameter of an image-side surface of the fifth secondary auxiliary separating piece.

16. The optical camera lens assembly according to claim 1, wherein
the object-side surface of the first lens is a concave surface, and the image-side surface of the first lens is a convex surface;
the second lens has a positive refractive power, an object-side surface of the second lens is a convex surface, and the image-side surface of the second lens is a concave surface;
the third lens has a positive refractive power, an object-side surface of the third lens is a convex surface, and the image-side surface of the third lens is a convex surface;
the fourth lens has a negative refractive power, an object-side surface of the fourth lens is a concave surface, and the image-side surface of the fourth lens is a convex surface;
the fifth lens has a positive refractive power, the object-side surface of the fifth lens is a concave surface, and the image-side surface of the fifth lens is a convex surface; and
the sixth lens has a positive refractive power, an object-side surface of the sixth lens is a convex surface, and the image-side surface of the sixth lens is a concave surface.
